(19) United States
(12) Patent Application Publication
(10) Pub. No.: US 2008/0086501 A1
(43) Pub. Date: Apr. 10, 2008

(54) Adaptable computing architecture

(75) Inventor: Arthur Paul Levine, Los Angeles, CA (US)

Correspondence Address: Trellis Intellectual Property Law Group, PC, 1900 EMBARCADERO ROAD, SUITE 109, PALO ALTO, CA, 94303, US

(73) Assignee: RhythmBase Communications, Inc., Los Angeles, CA (US)

(21) Appl. No.: 11/904,599

(22) Filed: Sep. 26, 2007

Related U.S. Application Data
(60) Provisional application No. 60/847,129, filed on Sep. 26, 2006.

(51) Int. Cl. G06F 17/30

(52) U.S. Cl. 707/103 Y; 707/E17.055

(57) ABSTRACT

A computing architecture. In one embodiment, the computing architecture includes a kernel that contains data and instructions in one or more database tables. A first mechanism selectively executes instructions stored in the one or more database tables to instantiate one or more objects or wrappers to encapsulate one or more computing resources. In a more specific embodiment, the one or more database tables are verticalized and include one or more atomic fields. The first mechanism further includes a second mechanism for encapsulating the kernel within an object that provides a layer of abstraction between the kernel and the one or more objects, which are coupled thereto.

### CLAIM OF PRIORITY

This application claims priority from U.S. Provisional Patent Application Ser. No. 60/847,129 filed on Sep. 26, 2006, attorney docket No. 100154-000100US, entitled “META-OPERATIONS INFRASTRUCTURE SYSTEM” which is hereby incorporated by reference as if set forth in this application in full for all purposes.

### BACKGROUND OF THE INVENTION

This disclosure relates generally to computing architectures and more specifically relates to digital processing hardware and software architectures and methods for organizing and accessing data in computer systems.

Architectures for facilitating computing are employed in various demanding applications including database design, data center design, parallel processing systems, Artificial Intelligence (AI), gaming, enterprise design, educational research, online community implementation, distributed processing systems, such as Service Oriented Architectures (SOAs), and so on. Such applications often demand robust flexible architectures that can readily accommodate changes, including the addition of computing resources.

Computing architectures capable of accommodating changes are particularly important in enterprise or business applications, which often require frequent changes to computing environments. Unfortunately, conventional computing architectures must often be redesigned or reconfigured to accommodate changes in underlying data structures. In addition, such architectures often lack effective mechanisms or structures to readily accommodate legacy systems. Consequently, changes to computing environments using such conventional architectures often necessitate costly modifications, which may include replacing computing resources, such as software applications and accompanying computers. This may undesirably limit computing environment evolution.

### BRIEF DESCRIPTION OF THE DRAWINGS

FIG. 1 is a diagram of an example embodiment of a computing architecture employing an underlying data architecture.

FIG. 2 is a diagram of an alternative embodiment based on the example embodiment of FIG. 1, which illustrates certain graphical components of a modeling language.

FIG. 3 is an illustrative embodiment based on the example embodiment of FIG. 1 and adapted to run on a Relational DataBase Management System (RDBMS) and to selectively instantiate a relational database.

FIG. 4 is a flow diagram of a first example method that is suitable for use with the embodiments of FIGS. 1-3.

FIG. 5 is a flow diagram of a second example method that is suitable for use with the embodiments of FIGS. 1-3.

FIG. 6 illustrates a first part of table entries and information according to an embodiment of the invention.

FIG. 7 illustrates a second part of table entries and information according to an embodiment of the invention.

FIG. 8 illustrates a third part of table entries and information according to an embodiment of the invention.

FIG. 9 illustrates a fourth part of table entries and information according to an embodiment of the invention.

FIG. 10 illustrates a fifth part of table entries and information according to an embodiment of the invention.

FIG. 11 illustrates a sixth part of table entries and information according to an embodiment of the invention.

FIG. 12 illustrates a seventh part of table entries and information according to an embodiment of the invention.

FIG. 13 is an illustrative embodiment #900 based on the example embodiment 50 of FIG. 2 and illustrates the recursively coupled tables adapted to provide relational object services (e.g., relational object: service, or relational object service,) embodiment 64 utilizing three pointer ID fields (e.g., Obj.ID, Meth.ID, Sub.ID) within the table relational object 58 embodiment and the table atomic array 60, 62 embodiments utilizing the array object model 54, 56 embodiments and the framework 61 embodiment

FIG. 14 is a further illustrative embodiment #950 of embodiments 200, 300, 400, 500, 600, 700, 800 from FIG. 6,7,8,9,10,11,12 based on the example embodiments 16, 18 of FIG. 1 and illustrates the recursive process flow for creating a service class kernel object with the recursively coupled tables 22, 24 embodiments, (e.g., Table I, Table II).

FIG. 15 is a further illustrative embodiment #960 of embodiments 200, 300, 400, 500, 600, 700, 800, 950 from FIG. 6,7,8,9,10,11,12,14 based on the example embodiments 16, 18 of FIG. 1 and illustrates the recursive process flow for creating a database class object with the recursively coupled tables 22, 24 embodiments, (e.g., Table I, Table II).

FIG. 16 is a further illustrative embodiment #970 of embodiments 200, 300, 400, 500, 600, 700, 800, 950, 960 from FIG. 6,7,8,9,10,11,12,14,15 based on the example embodiments 16, 18 of FIG. 1 and illustrates the recursive process flow for creating a database table class object with the recursively coupled tables 22, 24 embodiments, (e.g., Table I, Table II).

FIG. 17 is a further illustrative embodiment #960 of embodiments 200, 300, 400, 500, 600, 700, 800, 950 from FIG. 6,7,8,9,10,11,12,15 based on the example embodiments 16, 18 of FIG. 1 and illustrates the recursive process flow for creating a database table rows class object with the recursively coupled tables 22, 24 embodiments, (e.g., Table I, Table II).

FIG. 18 is an illustrative embodiment #1000 based on the example embodiment 12, 14 16, 18 of FIG. 1, embodiment 50 of FIG. 2 and illustrates the recursively coupled tables adapted to provide relational object services (e.g., relational object: service, or relational object service) relational object services encapsulation for a dynamic application service device and a dynamic architecture service device (e.g., Dynamic Architecture Services, Dynamic Architecture: Service Device:).

FIG. 19 is an illustrative embodiment #1100 based on the example embodiment 12, 14 16, 18 of FIG. 1, embodiment 50 of FIG. 2, embodiment 1000 of FIG. 18 and illustrates the recursively coupled tables adapted to provide virtual model relational object services (e.g., relational object: service, or relational object service) encapsulation for a dynamic application service device and a dynamic architecture service device (e.g., Dynamic Application Service Device:, and Dynamic Architecture: Service Device:).

FIG. 20 is an illustrative embodiment #1200 based on the example embodiment 12, 14 16, 18 of FIG. 1, embodiment 50 of FIG. 2, embodiment 1000 of FIG. 18, and embodiment 1100 of FIG. 19 and illustrates the recursively coupled tables adapted to provide virtual framework services encapsulation services (e.g., virtual framework: dynamic architecture: service device) encapsulation for virtual infrastructure services (e.g., virtual infrastructure: dynamic systems: service device, or virtual infrastructure: dynamic services: service device).

FIG. 21 is an illustrative embodiment #1300 based on the example embodiment 10, 16, 18 of FIG. 1, embodiment 50 of FIG. 2, embodiment 1000 of FIG. 18, and embodiment 1100 of FIG. 19 and embodiment 1200 of FIG. 20 adapted to a Artificial Intelligence, Dynamic Learning, Self-Constructing, Adaptable Simulation Machine

### DETAILED DESCRIPTION OF EXAMPLE EMBODIMENTS

An example computing architecture includes a kernel containing data, including instructions, in one or more database tables. A first mechanism selectively executes instructions stored in the one or more database tables to instantiate one or more objects or wrappers to encapsulate one or more computing resources.

In a more specific embodiment, the one or more database tables are verticalized and include one or more atomic fields. A second mechanism encapsulates the kernel within an object that provides a layer of abstraction between the kernel and the one or more additional objects, which are coupled thereto.

In an illustrative embodiment, the one or more database tables include a first table and a second table. The first table includes a first set of fields, wherein each field is associated with a predetermined object. The first table further includes a second set of fields that associate each predetermined object with a type. The second table is recursively coupled to the first table and includes a third set of fields. Each field of the third set of fields is a type that can be referenced by a type ID of the first table. A fourth set of fields included in the second table include additional information pertaining to each predetermined object.

For the purposes of the present discussion, a first table is said to be recursively coupled to a second table if the first table includes one or more keys, pointers, or other references to the second table, and the second table includes one or more keys, pointers, or other references to the first table.

In the specific embodiment, the first table and the second table are encapsulated within an object. An object may be any computing entity that is adapted to behave in a predetermined or standardized way, such as by receiving data from other objects, processing data, and sending data to other objects. Certain objects may provide a layer of abstraction between the contents of the objects and entities in communication with the objects.

A data manager manages data and instructions in the first table and the second table. The data manager operates based on instructions stored in the first table and/or the second table. In the specific embodiment, the first table and the second table are implemented via a verticalized database that includes one or more objects. A vertical database includes data such as entries or objects that are associated with other data predominantly by using references such as pointers, identification values (IDs), object hierarchies, etc. This is different from a horizontal database where the data relationships are predominantly defined by fixed data structures stored within the RDBMS, such as a database having tables, and tables having records, and records having fields, whereby in order to change data relationships the database structure definitions may have to be changed.

One aspect of the present invention uses a vertical object database as a persistent representation of data. However, standard database queries can be made on the data by translating all or a needed part of the object database into a horizontal relational database format at or prior to a time of responding to a query. The object database format can allow efficient modification of data relationships while the relational database format can provide intuitive, standardized and fast responses to database queries.

In a particular embodiment, data is maintained in the vertical object database and the database is translated to a horizontal relational database format at periodic intervals, such as once per day. Between translation intervals, the relational database can be queried using standard database query languages and techniques. Modifications to the data and database format are performed to the object database and are available in the relational database format after the next translation.

In another embodiment, the translation can be dynamic—that is, occurring at a time of, and in response to, a query on particular data. Only the relational database structures that are needed to respond to the query need to be translated. The translated data can be virtual and transient, such as only residing for a brief time in solid state memory, or it can be made more persistent such as by storing to a hard drive and maintained for multiple queries or multiple operations, as desired.

In general, the vertical database can be implemented in any suitable design. However, a preferred embodiment of a specific type of vertical database is described that uses a two-table approach. Many features of the two-table approach are described that may be adapted to other designs and operations, as desired.

A preferred embodiment is generally described with respect to a standard database query language called Structured Query Language (SQL). However, other suitable query languages or approaches may be used. Data may be incorporated within a Relational DataBase Management System (RDBMS). Objects in the database may include various types of data, including data used to execute methods, including various applications, such as services.

For the purposes of the present discussion, a method may be any computer or processor instructions adapted to perform an action, such as a data-read, write, compile program code, install operating system, or other operation. An atomic field may be any field, node, array element, record, and so on, that can only be changed by a process that completes. A process acting on an atomic field is said to either commit, i.e. complete its operations on the field, or abort. If the process aborts, the field remains unchanged. This property may enhance robust qualities of an underlying data structure, thereby preventing or reducing data corruption. A process acting on an atomic field is said to be implementing an atomic process. To modify an atomic field, an atomic process may make a copy of the field and then replace the previous field from which the copied field was copied only if the process commits.

Certain operations on an atomic object may be classified as reading, writing, or deleting. An operation or atomic process that modifies an atomic object, such as an atomic field, may be called a writer, and other processes may be called readers. A reader may acquire a read lock on the atomic object to be read. Similarly, a writer may acquire a write lock on an atomic object. Such locks may be maintained until the given process commits or aborts. After an atomic process either completes reading, writing, or aborting, the associated lock is released, allowing other processes to occur. Atomic actions may be nested and may be associated with sub-locks.

The novel design of certain embodiments discussed herein is facilitated by use of a central data model that employs verticalized recursively-coupled tables that store dynamic objects. The dynamic objects may include encapsulated executable instructions or methods that are included within an object, such as via a container or other layer of abstraction. In addition, the verticalized recursively-coupled tables themselves are encapsulated within an object. By reducing reliance upon static data structures and by encapsulating various architecture components, such as legacy systems, in a layer of abstraction, the resulting architecture can readily adapt and evolve to meet the needs of a given application.

For the purposes of the present discussion, a layer of abstraction may be a container, shell, or other interface for encapsulating or otherwise facilitating use of the entity around or over which the layer of abstraction is disposed. For example, the C programming language is said to be separated from processor operations via layers of abstraction, which include machine language. Machine language may be considered a type of interface between processor operations and C programming code. An abstraction may also be considered a generalization of a model, algorithm, or other entity, away from a specific implementation of the model, algorithm, or other entity.

Certain embodiments discussed herein address a growing need for enterprise meta-database systems, operational data storage systems, and data warehouse systems, that can combine disparate data stored in non-similar structures in non-similar formats from disparate sources in heterogeneous environments. Certain embodiments discussed herein provide a computing architecture and accompanying infrastructure capable of automatically adapting to changes in data structures and/or devices without requiring extensive manual coding changes.

For clarity, various well-known components, such as power supplies, computer networking cards, compilers, operating systems, Internet Service Providers (ISPs), firewalls, anti-hacking tools, and so on, have been omitted from the figures. However, those skilled in the art with access to the present teachings will know which components and features to implement and how to implement them to meet the needs of a given application.

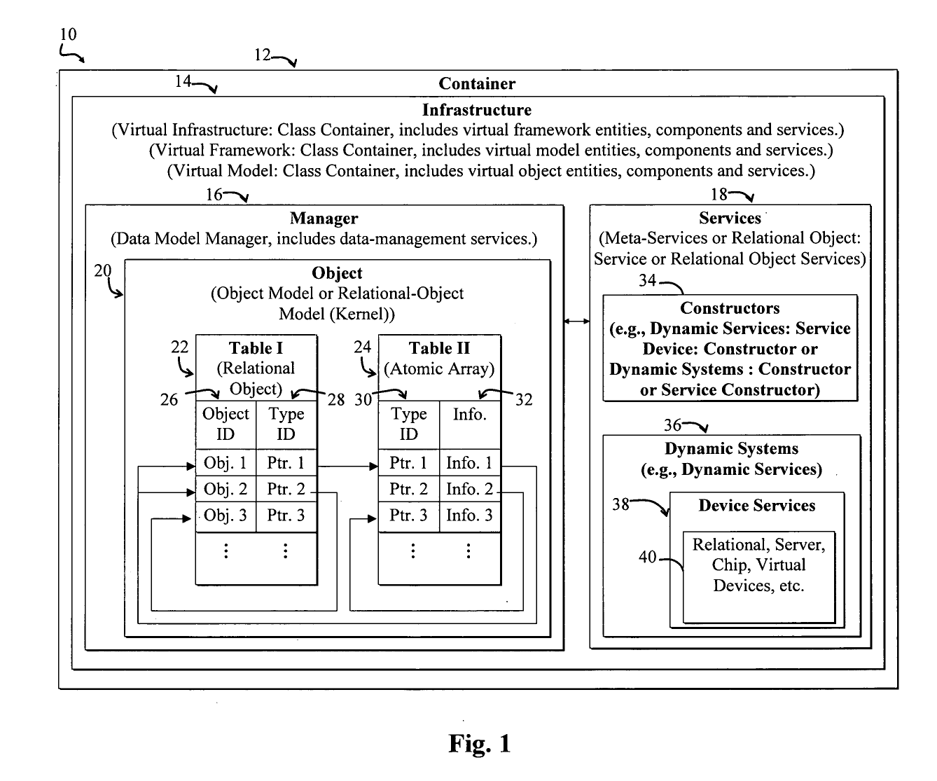

FIG. 1 is a diagram illustrating an example computing architecture 10. The computing architecture includes a first container 12, which represents an object or layer of abstraction that encapsulates an infrastructure object 14. Additional encapsulation layers, also called levels of abstraction, may be included between the infrastructure object 14 and the container 12 without departing from the scope of the present teachings.

The infrastructure object 14 encapsulates a manager 16, which encapsulates or otherwise controls or manages a kernel object 20. For illustrative purposes, the manager 16 is shown coupled to services 18, which are also incorporated within the infrastructure object 14. While the services 18 are depicted separately from the manager 16, in practice, the services 18 may be incorporated with the object represented by the manager 16. The services 18 represent an instantiation or virtualization derived from data stored in the kernel object 20.

The kernel object 20 includes a first table 22 and a second table 24. The first table 22 is encapsulated as a relational object. The second table 24 represents an object that encapsulates one or more atomic arrays.

For the purposes of the present discussion, a table may be any collection of organized data units. The organized data units may be fields, records, nodes, data points, array elements, and so on. Hence, an array, such as an array commonly used in the C-programming language, is considered to be a type of table.

A database may be any structured collection of records or data that is stored via coding constructs. A coding construct may be any structure, such as a field or table, implemented via machine-readable instructions or codes.

The first table 22, which may be implemented via a relational object, includes a first object-identification column 26 and a first type-identification column 28. For the purposes of the present discussion, a relational object may be any object that includes one or more tables or is otherwise based upon one or more tables.

The second table 24, which may be implemented via one or more atomic arrays, includes a second type-identification field 30 and a second information column 32. For the purposes of the present discussion, an atomic array may be any table or other organization of data where associated elements, fields, nodes, records, or other components are atomic, as defined, above.

For illustrative purposes, the first object-identification column 26 is shown including several object identifications (e.g., Obj. 1, Obj. 2, Obj. 3, etc.). The object identifications in column 26 may represent pointers to other objects in other tables, such as the second table 24. In addition, each object identification in column 26 is associated with a corresponding type-identification pointer (e.g., Ptr. 1, Ptr. 2, Ptr. 3, etc.) in the adjacent type-identification column 28. The type-identification pointers 28 may point to corresponding pointers in the second type-identification column 30 of the second table 24. Note that reference to specific data structures such as pointers is only for purposes of illustration unless otherwise noted. Such data structures or mechanisms may typically also be implemented by other means such as with an index, ID, membership in an array, object, etc. as is known in the art.

The second information column 32 includes additional information associated with a given object identified in the first object-identification column 26. The additional information may include additional object definitions, method code for implementing a service, and/or one or more additional pointers that reference one or more objects identified by the first table 22. For illustrative purposes, the first pointer (Ptr. 1) in the first type-identification column 28 points to the corresponding pointer (Ptr. 1) in the second type-identification column 30, which associates the first object identification (Obj. 1) with additional information (Info. 1). The additional information (Info. 1) includes pointers back to the first object (Obj. 1) and the second object (Obj. 2) in the first object-identification column 26. The first table 22 is said to be recursively coupled to the second table 24, as the tables 22, 24 reference each other via pointers, which may also be called database keys in certain implementations.

While in the present specific embodiment, each table column 26-32 is shown including a single column of fields, each column 26-32 may include one or more additional columns without departing from the scope of the present teachings. The tables 22-24 represent recursively coupled verticalized tables.

The object 20 containing the tables 22, 24 is also called an object model or a kernel of an object-relational model. All data, including executable instructions for methods, that is employed by the architecture 10 may be stored via the object 20 or via one or more instantiations of the object 20.

The manager 16, also called the Data Model Manager, includes methods for implementing data-management services for managing data in the tables 22, 24. In the present specific embodiment, the manager includes instructions, which are stored via the tables 22, 24, for instantiating the services 18. Executable code or instruction for instantiating the services 18 is also stored in the encapsulated tables 22, 24. Services 18 may include meta-services, wherein a meta-service manages or operates on another service. In addition, the services 18 themselves are encapsulated within an object, which may be written as “Relational Object: Service” where the use of a colon indicates that the Service is a function or method that is a property of the Relational Object. In addition, the “Relational Object: Service” may be referred to herein as “Relational Object Service” and should be understood to have the same meaning. In general, variations on object, structure, properties, hierarchies and other data organization may vary from the specific embodiments shown herein and yet remain within the scope of the invention unless otherwise noted.

For illustrative purposes, the services 18 are shown including a constructors object 34, which is adapted to selectively instantiate encapsulated dynamic systems, virtual device constructors, and so on. The constructors object 34 and the dynamic systems object 36 are both instantiated from the tables 22, 24 and are encapsulated within one or more objects. The tables 22, 24 may be encapsulated via one or more object containers, and the containers themselves may also be instantiated from the tables 22, 24 in the object model 20.

For the purposes of the present discussion, dynamic systems may be any services that are adapted to change in nature as needed for a particular application. A virtual device constructor may be any computer code adapted to construct a virtual instance of another entity, such as a device.

A virtual instance of a device may be a software entity that is adapted to behave similarly to the device or that is otherwise adapted to facilitate interfacing a given device with another device or entity. For example, a given hardware device may employ different virtual instances to facilitate communicating with different applications that use the device.

Virtualization may refer to the abstraction of computing resources, such as via encapsulation. Virtualization may also refer to a technique for hiding physical characteristics of a computing resource from other systems or applications interacting with the resource, such as via creation of a special interface. For example, virtualization may be employed to make a given single physical resource, such as a server, compiler, operating system, application, or storage device, appear to function as multiple logical resources. Alternatively, multiple physical or logical resources may be virtualized to appear as a single logical resource. Virtualization technologies often hide technical details of a computing resource via encapsulation or other mechanisms.

While each of the tables 22, 24 are shown including two columns, each table 22, 24 may include more than two columns without departing from the scope of the present teachings. Furthermore, the first table 22 and the second table 24 may be concatenated into a single table. The resulting combined table is considered a super table that includes sub-tables.

The computing architecture 10 may be considered an architecture that includes a first object 20 defining a first table 22, wherein the first table includes one or more pointers 28. A second table 24 communicates with the first table 22, wherein the one or more pointers 28 in the first table 22 reference information 32 in the second table 24. In a specific implementation, the information 32 includes a method 16 for instantiating one or more additional objects 18, wherein data components of the one or more additional objects are stored via the first table 22 and the second table 24 or instances thereof. The second table 24 includes one or more atomic fields 32.

Alternatively, the computing architecture 10 may be considered an architecture that includes a first table object 22 with a first column 26 for identifying one or more objects, and a second column 28 for accessing or invoking additional information 32 associated with each of the one or more objects 26. In a specific implementation, the additional information 32 includes a method. The first column 26 includes one or more object identification pointers or numbers (Obj. 1, Obj. 2, Obj. 3, etc.) associated with the one or more objects. The second column 28 includes one or more pointers (Ptr. 1, Ptr. 2, Ptr. 3, etc.) to a second table 24. The one or more pointers 28 point to an object or field (e.g., Info. 1, Info. 2, Info. 3) in the second table 24 that points back to one or more fields (e.g., Obj. 1, Obj. 2, etc.) in the first table 22. The second table 24 includes a type table or column 30. The first table 22 and the second table 24 are verticalized and include one or more atomic fields.

The following discussion of table normalization is intended to facilitate an understanding of benefits afforded via certain embodiments discussed herein.

Certain databases store data in so-called horizontal structures. An example table for tracking books checked out at a library includes a row of various horizontal fields for each book that is checked out. Example fields include book identification, user name, address, phone number, and so on. If a user checks out multiple books, the user name, address, phone number, and so on are repeated in separate rows for each book that is checked out. This results in undesirably redundant repetition of data, such as user name address, and so on, in the database.

A database manager may wish to add additional fields to the database, such as fields indicating the date on which the book was checked out, the date on which the book is due for return, and so on. When the fields are inserted into the horizontal structure, the rows become wider, and relative positions of certain data in the table may change. Unfortunately, external programs, such as services, that wish to access the underlying table must often be changed to accommodate changes to the table. Data stored in this way is said to be stored in a flat or horizontal file or table. Such tables are also typically “static” in that they are maintained and used in a single persistent structure.

To address this problem, table data may be verticalized, i.e. normalized. In the above example, different tables may be used to store book identification information, user name, user address, and so on. Each table may have a pointer or other identification information associating a given field with another field in another table. In this way, for example, when a user checks out multiple books, each book may be associated with a pointer to the corresponding user information in another table. This limits undesirable repetition of the user information.

In addition, an additional table, called a type table for the purposes of the present discussion, may be added. The type table associates each type of information with a first pointer or identification and associates a second pointer with a given user. The second pointer may be associated with the type pointer. In this way, when a database administrator or manager wishes to add new fields, such as checkout and return dates, such fields may simply be appended to the type table along with a pointer to the given user, without changing the underlying structure or way external programs access the tables. The additional fields and associated data are said to be provisioned. For the purposes of the present discussion, data stored in this way is said to be stored vertically or in a verticalized file or table. This facilitates provisioning of additional data in a table.

Similarly, certain embodiments discussed herein, including the computing architecture 10, may employ verticalized table structures 22, 24, also called relational structures, encapsulated within one or more objects 12-16, 20, to represent underlying data structures. This further improves adaptability of the architecture to underlying changes in data structures, which are implemented as objects in certain embodiments discussed herein, and facilitates growth of the overall architecture 10. Hence, using the verticalized tables 22, 24 in the object 20 to represent the data model for the computing architecture 10 enhances the ability of the computing architecture to evolve and change as needed.

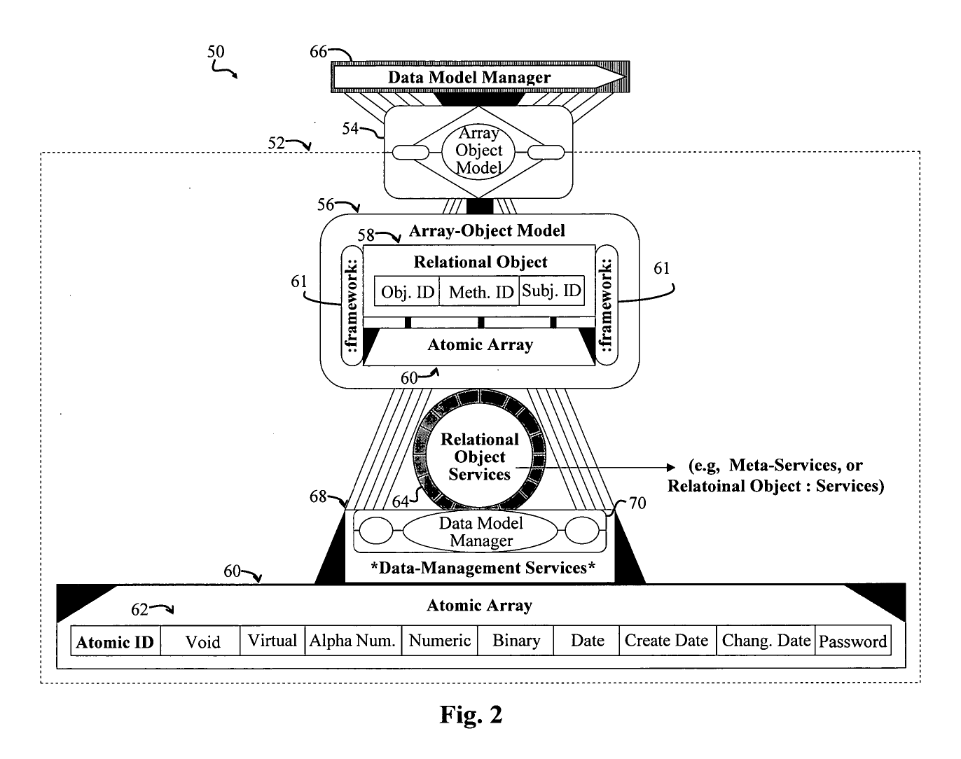

FIG. 2 is a diagram of an alternative embodiment of a computing architecture 50 based on the example embodiment 10 of FIG. 1. FIG. 2 also illustrates certain example graphical components or symbols of a so-called modeling language or architecture-specification syntax.

For the purposes of the present discussion, a language may be any system of symbols, such as graphical, written, or audible symbols, and rules to implement them. The modeling language or specification discussed herein represents a so-called semantic ontological meta-modeling language that is employed to represent the architecture 50. The meta-modeling language is adapted to further facilitate adaptability, growth, and general advancement of a computing architecture or computing environment, as discussed more fully below.

The computing architecture 50 includes a so-called array-object model 52, which is identified by a graphical symbol 54. The array-object model 52 is encapsulated within an array-object-model object 56, which includes a relational object 58 that is coupled to an atomic array 60. The relational object 58 is analogous to the first table 22 of FIG. 1, and the atomic array 60 is analogous to the second table 24 of FIG. 1. The relational object 58 and the atomic array 60 are implemented via a framework object 61. The framework object 61 includes one or more entities, elements, and/or relationship components for implementing and/or instantiating the array-object model object 56 or one or more versions thereof. The relational object services functionality 64 may further facilitate implementing and/or instantiating the array-object model 56. The relational object services functionality 64 may be partly specified by the name relational object: service or meta-services. The relational object services functionality 64 may further provide additional functionality or methods to facilitate using relational object structures, such as the relational object 58 and atomic array 60, in the array-object model 52. The atomic array object 60 may further include virtual databases stored therein. In addition, certain services, such as relational-object services may be included, identified, and/or defined by one or more records in the relational object 58.

A data-model manager, which is identified by a first manager symbol 66 and a second symbol 68, may encapsulate the array-object model 52. Alternatively, the data-model manager 66, 68 may be encapsulated within the array-object model 52. The data-model manager 66, 68 includes data-management services for supporting and maintaining dynamic relational structures within the relational-object model represented by the array-object model object 56. Data-management services may be derived via data and instructions maintained in the relational object 58 and atomic array 60. The data-model manager 66, 68, which may also be partly specified by the name data model: manager, is also identified by a second data-model manager symbol 70.

For illustrative purposes, the atomic array 60 is shown expanded to include various atomic fields 62, which may also be called array elements, nodes, or records. Example atomic fields include an atomic identification (ID), void, virtual, alpha numeric, numeric, binary, current date, create date, change data, and password fields. Example fields in the relational object 58 include object ID, method ID, and subject ID. The relational object 58 and the atomic array 62 may include additional pointers and fields that recursively couple certain fields in the relational object 58 with certain fields in the atomic array 62. For example, object ID, method ID, and subject ID may act as pointers in the relational object 58 that refer to or point to data in the atomic array 60 or in another table, which in turn references the pointers in the relational object 58. Hence, the relational object 58 is recursively coupled to the atomic array 60.

In addition, the relational object 58 may include other objects, such as relational object services 64, array objects, and relational objects. Such objects may be employed to create virtual instances of other objects and to place containers around other resources, such as constructors, devices, systems, and databases in a given computing environment.

The data-model definition, as represented by the array-object model 56, may be used to define other objects intended to act upon or be based upon data or instructions included in the constituent relational object 58 and atomic array 60.

Those skilled in the art with access to the present teachings will appreciate that the computing architecture 50 may be expanded and encapsulated in other objects without departing from the scope of the present teachings. In general, the computing architecture 50 is adapted to grow into any of various forms to meet the needs of a given application or implementation.

In the present embodiment, an example language may be employed to identify objects by name, wherein the name identifies parent objects in order. For example, an object D, which is contained within an object C, which is contained within and object B, which is contained within an object A, may be identified as object A:B:C:D. As a more specific example, the framework 61 may be specified by the name array-object model: entity relationship model: framework. This name suggests that an entity-relationship object encapsulates the framework object 61, and that the entity-relationship object is encapsulated by the array-object-model object 56.

In addition, the language may incorporate certain graphical symbols, e.g., symbols 54, 64, 70, to refer to certain objects or certain containers of the objects. An overall architecture that incorporates several objects in different hierarchical layers may be generally specified by a set of names identifying each object of the architecture. Such a modeling language or specification may facilitate designing hierarchical layers of abstraction in an architecture and to facilitate managing the overall architecture or infrastructure within a shell-like environment, also called a relational-object environment.

The present example language is said to be a semantic language in that it may be defined by the rules generating the language structures or symbols rather than the vocabulary of primitives itself. The term “semantics” may also imply that domain knowledge is used to make software more intelligent, adaptive, and efficient.

The language is said to be an ontological language in that constituent terms, names, or symbols may represent sets of relationships (as represented by data models) that in turn represent a certain domain. The term “ontology” may refer to any set of relationships, such as a set of relationships defining a data model that represents a “domain” and is used to reason about the objects in that domain and the relations between them. For example, an ontology about animals might specify that a class “dog” is a sub-class of the class “mammal” and that classes “mammal” and “reptile” are disjoint. Similarly, a given computing object, such as the relational object 58, may represent a class or set of relationships defining a so-called domain or grouping of relationships.

The language is said to be a meta-modeling language in that it may be employed or extended to specify other symbols or languages to define other containers or objects. For the purposes of the present discussion, a meta-modeling language may be any language used to construct a set of concepts or to define another language. Similarly, the computing architecture 50 may be considered to implement a meta-application for implementing a high level of abstraction by encapsulating entities within the architecture 50 within predetermined objects.

In the present specific embodiment, inheritance relationships between objects may be bidirectional. However, different inheritance relationships may be employed without departing from the scope of the present teachings.

The following analogy pertaining to Operating Systems (OSs) is intended to facilitate an understanding of benefits afforded via certain embodiments discussed herein. Early versions of computer operating systems were developed almost entirely using assembly code and machine language, which are considered relatively low-level programming languages. For example, machine language programming involves writing computer code in the form of binary states, such as 1s and 0s, which may be read by a computer processor. The 1s and 0s may be representative of high or low voltage states in hardware latches and flip-flops as output by certain physical logic gates within a computer processor. Assembly language programming involves writing computer code in the form of symbols that represent one or more groupings of 1s and 0s. Assembly language is said to be a higher-level language in that it provides a so-called layer of abstraction above machine language to facilitate programming, also called coding. Operating systems implemented in assembly language or machine language were often relatively inflexible, since the addition of new computing resources, such as hardware, often required re-coding of the OS to accommodate the resources.

Subsequently, operating systems, such as UNIX, implemented a so-called kernel architecture. For the purposes of the present discussion, a kernel may be the central part of a system or architecture, such as an operating system, which facilitates managing system resources and communications between accompanying components, such as hardware and software modules.

An Operating System (OS) may be any program adapted to manage hardware and/or software resources of a computer. A computer may be any processor in communication with a memory. An example OS may perform basic computing tasks, such as controlling and allocating memory, prioritizing the processing of instructions, controlling input and output devices, facilitating networking, and managing files.

The UNIX kernel, which was originally written in assembly or machine language, was encapsulated in a shell, which is a type of object. Each shell or object provides a layer of abstraction between that which is contained within the object and external entities, such as other objects.

The shell was designed to readily interface with other modules written in higher-level languages, such as the C programming language. The resulting architecture increased portability and adaptability of the operating system. Various solutions to computing problems were then implemented in so-called shells that could readily interface with the OS kernel and accompanying shell. The development of certain shells led to the development of other shells, which facilitated growth of UNIX-based computing environments.

Embodiments discussed herein may be employed to provide shells, called objects herein, around various computing entities, such as various types of data and computing resources, not just software components or data structures. In accordance with embodiments discussed herein, an entire architecture may be incorporated within an object, and sub-components of the architecture may themselves be represent or be contained within their own objects. Consistent behavioral properties of the objects facilitate growth and expansion of an entire computing environment. For example, certain architectures implemented in accordance with the present teachings may readily interface with other similar architectures.

In addition, in accordance with the present teachings, legacy systems (e.g., certain chip devices or other application 40 of FIG. 1) are encapsulated within objects that are compatible with other architectural components. The objects are configured to hide or convert any inconsistent behavior of underlying legacy systems so that the resulting behavior of a given legacy system as seen through the encapsulating object is compatible with the overall architecture.

Certain embodiments discussed herein provide a kernel-like infrastructure and one or more abstraction layers to allow for a modular adoptive development environment that evolves with technology innovation, yet retains referential historical integrity of all respective data, legacy systems, applications and infrastructures.

While certain programming languages, such as C++, have successfully used objects to facilitate computer programming, object concepts have yet to be applied to an entire computing architecture that includes legacy systems, such as preexisting hardware; software components, such as services; and the data itself. For example, conventional object oriented programming languages, such as C++, often continue to rely upon static underlying data structures that limit the ability of the resulting programs to accommodate changes in the underlying data structures. This may promote the so-called impedance mismatch phenomena where object oriented programming languages often have difficulty interfacing with databases or using underlying database structures as objects. Furthermore, conventional object-oriented methodologies often do not effectively handle or support data management and data integrity issues.

By encapsulating the entire computing environment and associated infrastructure as one or more objects within a data-centric relational model, certain embodiments discussed herein provide a missing foundation to enable current and legacy systems to co-exist and continue evolving toward a more cohesive operational standard and technology model.

Certain embodiments disclosed herein implement a relational-object data model combined with a compiler-based design to maximize adaptability and minimize any required re-coding of components within the accompanying computing architecture.

Computing architectures discussed herein, such as the architectures 10 and 50, of FIGS. 1 and 2, are said to exhibit a compiler-based design, since the architectures employ or implement encapsulation or act as a such as via so-called object containers or shells. The encapsulation may be said to perform the function of a constructor (e.g., constructors object 34 of FIG. 1) or service constructor, which may be further said to perform the function of a compiler or interpreter or converter or assembler or provisioner or instantiator or translator. The encapsulation facilitates or performs any requisite translations to make different underlying processes compatible or executable. The term “compiler” as used herein refers to an entity that is adapted to perform translation of any type. However, the term “compiler” is commonly used specifically to refer to a computer program that translates one type of computer language to another. For example, a C-compiler may translate the C programming language to machine language for execution by a processor.

Certain embodiments discussed herein are designed with the understanding that the core of many computing environments is data, which includes the data or instructions defining program code used to access the data itself and which may include one or more operating systems employed by the architecture. Computing architectures discussed herein generally employ a compiler-based design, wherein application aspects represent data points or collections. This facilitates dynamically loading and compiling application code. All constituent program code, system code, or data structures may be stored via the data model and accompanying objects (e.g., the object 20 of FIG. 1 or the array-object model 56 of FIG. 2).

Hence, certain embodiments discussed herein employ a design or architecture wherein every aspect of the application is, or can be used, as a data-point, or data-collection represented by an object. Such data points or collections may be employed to instantiate an instance of an application or system infrastructure, thereby creating a virtual environment that can dynamically provide, load and compile, any applicable system or application code. The physical devices, operating systems, or a compiler itself, can be provisioned to create, on demand, any working computing environment, as needed, since all of the related program code, system code, or data structures are all stored within the overall architecture.

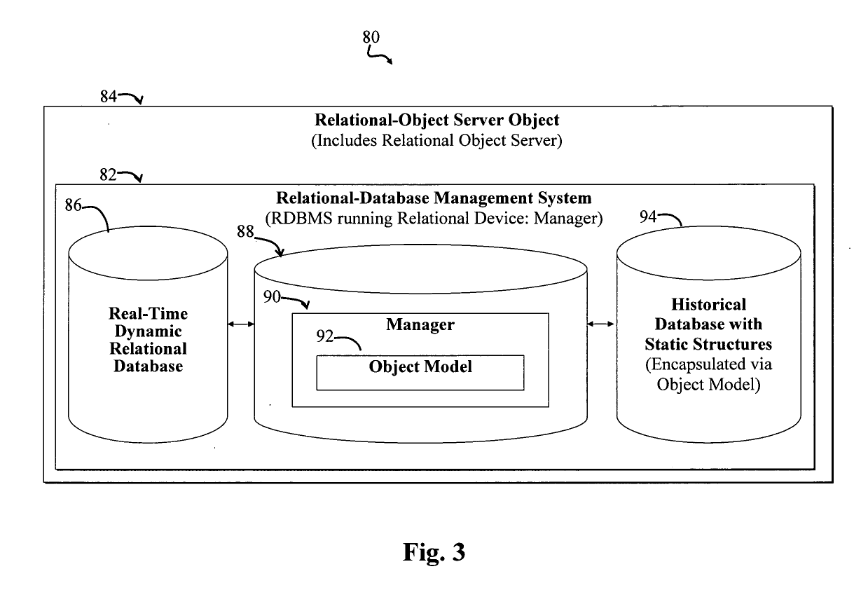

FIG. 3 is an illustrative embodiment 80 based on the example embodiment 10 of FIG. 1 and adapted to run on a Relational-DataBase Management System (RDBMS) 82 within a relational-object server object 84. The architecture 80 may be used to selectively instantiate a relational database 86, as discussed more fully below.

The RDBMS 82 includes a manager object 88, which includes a data-model manager 90 that governs an object model 92. The object model 92 may be implemented via an object that is similar to object 20 of FIG. 1 or the array-object model object 56 of FIG. 2. The manager 90 may be implemented similarly to the manager 16 of FIG. 1 or the data-model manager 66, 68 of FIG. 2. The RDBMS also runs an historical database 94, which for illustrative purposes includes one more static database structures. The historical database 94 is encapsulated within an object model object and may be instantiated via the manager 90 and object model 92.

For the purposes of the present discussion, a data model or a database model may be any theory or specification describing how a dataset or database is structured and/or used. An object database may be any database in which information is represented in the form of objects. An Object DataBase Management System (ODBMS) may be any system for managing or controlling an object database. A database may be any collection of data in a structure. An RDBMS may be a database management system in which data is stored in the form of tables and the relationship among the data is also stored in the form of tables.

In operation, the manager 90 selectively employs contents of the object model 92 to instantiate the real-time dynamic relational database 86. The real-time dynamic relational database 86 may be implemented via one or more various well-known databases, such as Oracle or Microsoft SQL. Code for executing the databases may be stored in one or more recursively coupled verticalized tables maintained in the object model 92.

Instantiation of the real-time dynamic relational database 86 via the manager 90 and object model 92 may facilitate incorporating changes to underlying data maintained via the object model 92. In certain applications, the real-time dynamic relational database will include a horizontal or flat file for easy or high-speed data entry and access, where the flat file is selectively verticalized or decomposed into the tables maintained via the object model 92. The decomposition of databases, services, applications, and so on may be implemented via instructions running on the manager 90 or elsewhere. Such instructions may be stored via the object model 92.

Certain object encapsulation may be temporarily removed to facilitate high-end performance. The resulting data and/or instructions may be maintained via a relational database, such as the database 86. Hence, the architecture 80 demonstrates that different applications can be instantiated from various objects arising from the kernel maintained via the object model 92 and accompanying manager 90. After modifications are made to the high-speed relational database 86, the resulting data may be saved in the underlying structure represented by the object model 92. In this case, the original encapsulated data structures are analogous to a base atomic object, while the high-speed relational database 86 is analogous to a temporary atomic object that is operated on before the results are saved and replace the base atomic object.

Data in the historical database 94 may be accessed via the real-time dynamic relational database 86 via one or more encapsulation containers or layers of abstraction afforded by the object model 92. This enhances compatibility between any legacy databases implemented via the historical database 94 and the real-time dynamic relational database 86.

As another example, the object model 92 may incorporate, store, and/or selectively instantiate the entire specification for Structured Query Language (SQL). SQL may be stored or incorporated as a method within one or more objects within the object model 92.

In general, when data in the object model 92 is to be changed, a copy of the previous version is maintained until the associated services or applications commit to completing a given process pertaining to the data. The object model 92 is said to exhibit atomicity.

Hence, the present computing architecture 80 is based on dynamic or readily changeable data structures rather than static data structures, also called data models. For the purposes of the present discussion, a static data structure may be any data structure that is not adapted to readily change its structure. For example, a static array may have a fixed number of fields or elements.

A dynamic data structure may be a data structure that may readily change, such as by adding or removing fields, rearranging relationships between fields, rearranging the organization of fields or records, and so on. A method may be any computer instruction for performing an action. The instruction itself may be considered a type of data that may be stored via underlying dynamic data structures discussed herein.

Dynamic data structures may be stored within a database management system or file management system, such as the RDBMS 82, along with processes, computer calls, and object-oriented methods (software that execute services), that employ or operate on the underlying data and accompanying structures.

Conventionally, any required changes to underlying static data structures stored in the historical database 94 necessitated corresponding changes to processes or other databases that employed or referenced the data structures. Use of the object model 92 and manager 90 facilitate overcoming the need to change the real-time dynamic relational database 86 to accommodate changes to the historical database 94.

In addition, changes to computing infrastructure or resources, such as devices and applications, such as services, often necessitated changes to other programming code within the overall architecture. Certain embodiments discussed herein may obviate this need.

While the computing architecture 80 is shown implemented via an RDBMS, other implementations are possible. For example, the manager object 88 and accompanying data manager 90 and object model 92 may alternatively be implemented within a data server running within a computer operating system, or within code running within a computer system chip or Basic Input/Output System (BIOS), or in other environments.

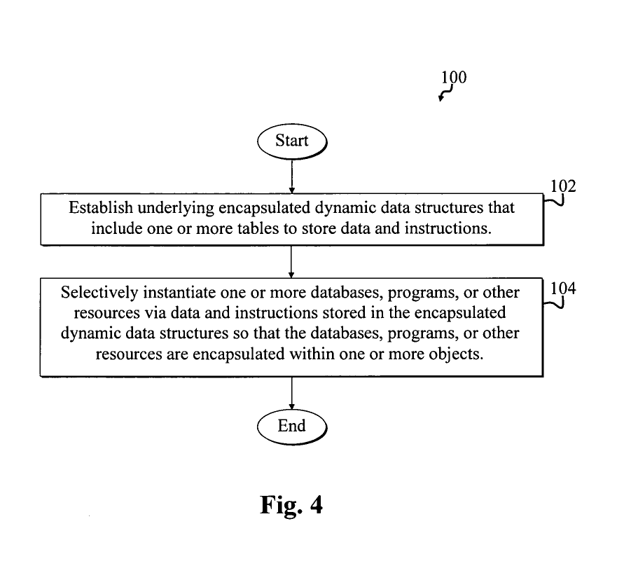

FIG. 4 is a flow diagram of a first example method 100 suitable for use with the embodiments 10, 50, 80 of FIGS. 1-3. The method 100 includes a first step 102, which includes establishing encapsulated dynamic data structures that underlie a computing environment or architecture. The underlying dynamic data structures include one or more tables to store data and instructions. In one embodiment, the tables include verticalized tables with one or more atomic fields.

A second step 104 includes selectively instantiating one or more databases, programs, or other resources via data and instructions stored in the encapsulated dynamic data structures so that the databases, programs, or other resources are encapsulated within one or more objects.

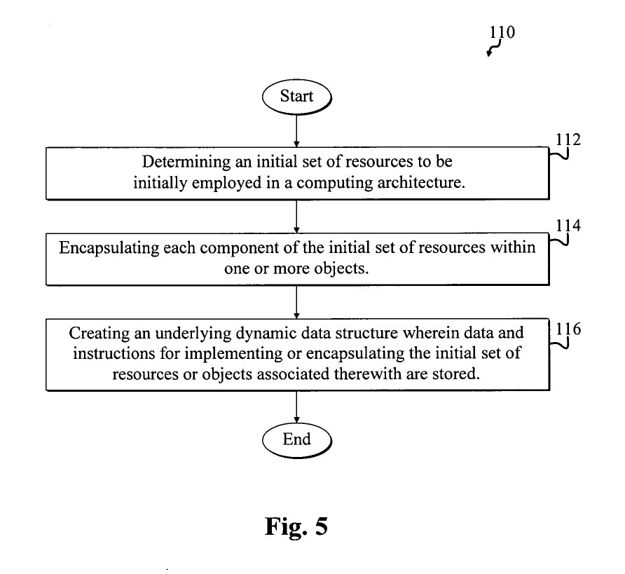

FIG. 5 is a flow diagram of a second example method 110 suitable for use with the embodiments 10, 50, 80 of FIGS. 1-3. The second example method 110 includes an initial step, which involves determining an initial set of resources to be initially employed in a computing architecture.

A subsequent encapsulation step 114 includes encapsulating each component of the initial set of resources within one or more objects.

Next, a creation step 116 includes creating an underlying dynamic data structure wherein data and instructions for implementing or encapsulating said initial set of resources or objects associated therewith are stored.

Those skilled in the art will appreciate that more or fewer steps may be added to the flowcharts herein without departing from the scope of the invention. It should be apparent that steps may be reordered or modified and that the same functionality may be achieved, unless otherwise noted.

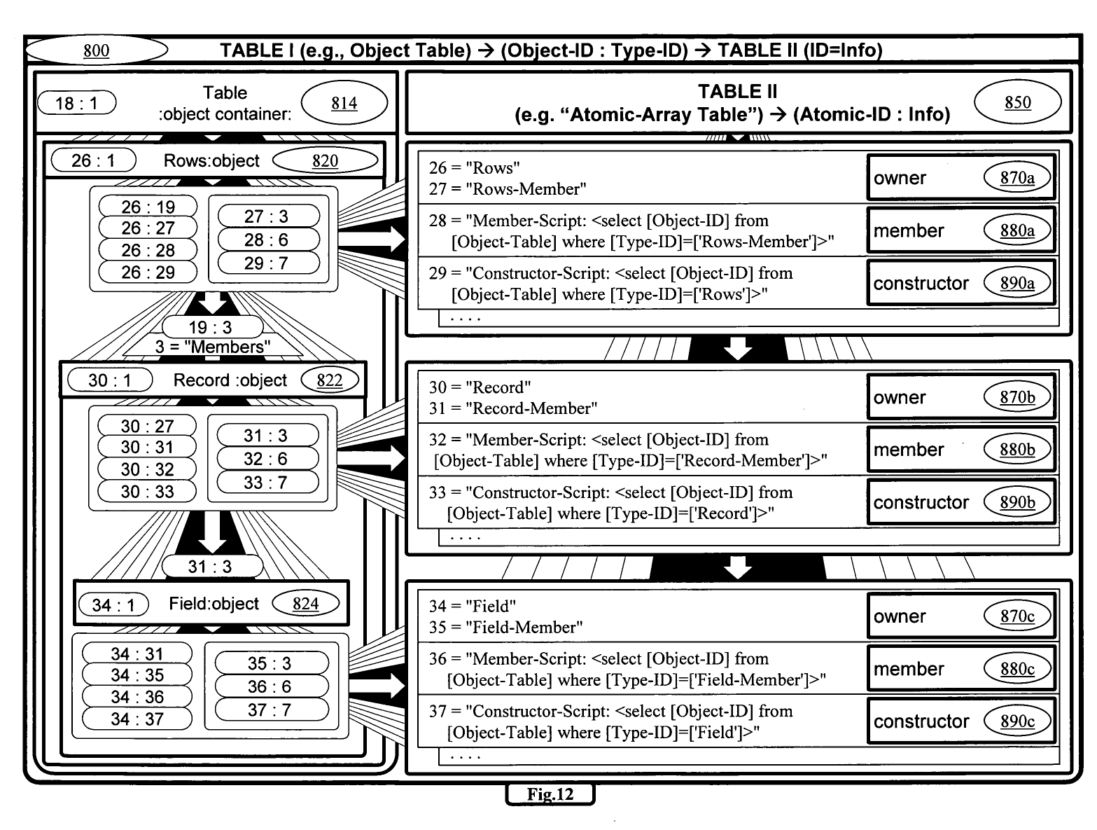

FIGS. 12-21 are next discussed to show more details of a specific two-table embodiment using the arrangement described above in the discussion of FIG. 1. It should be apparent that various actions and mechanisms presented in connection with the two-table approach may be adapted for use with three or more tables unless otherwise noted.

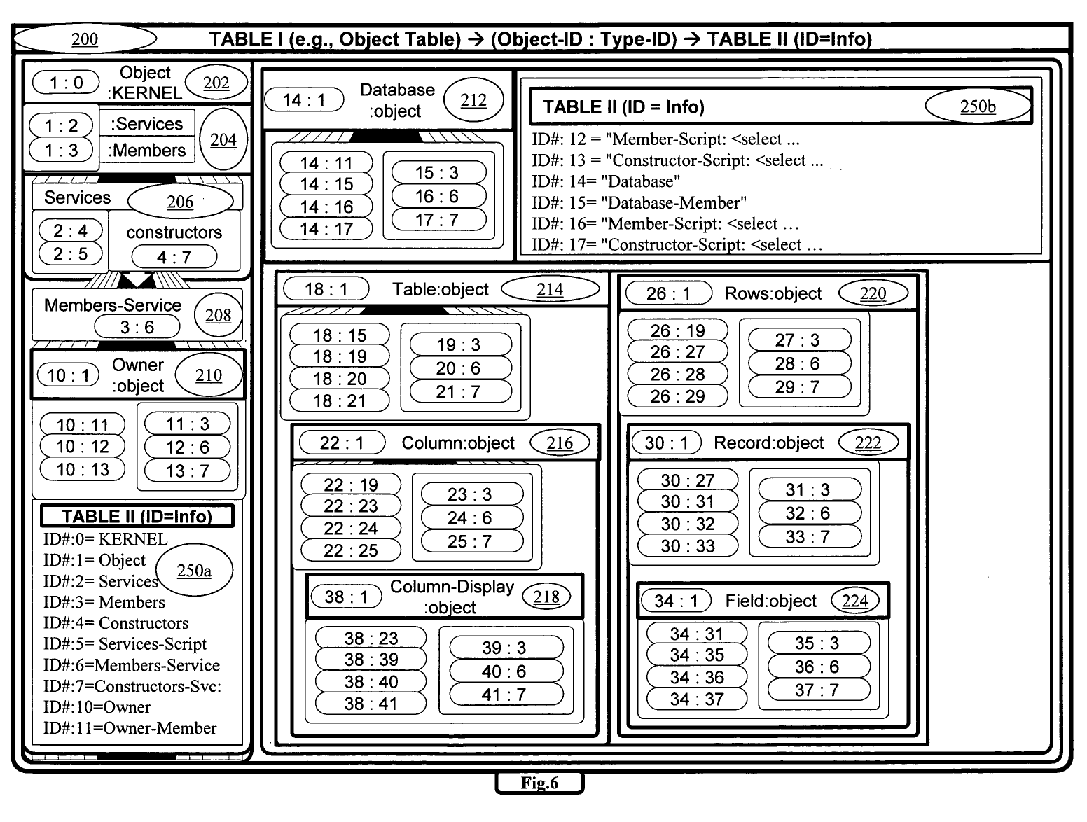

FIG. 6 shows a first part 200 of Table I and II entries. Each entry in Table I is shown in a rounded square with the first field (left side) value indicating an object ID followed by a colon and the second field (right side) value indicating the type ID. Similarly, entries in Table II are illustrated using a type ID value on the left side followed by an equal sign (“=”) and a right side information description of the value type. For ease of illustration simple numbers or descriptions are used. It should be apparent that in an actual implementation each value can be defined in any suitable format or structure (e.g., single or double word integer, floating point value, character string, pointer, array, etc.).

The example application shown in FIGS. 6-12 uses a typical relational object database kernel shell encapsulation service. Kernel object 202 is shown providing encapsulation for services and members 204 which provides recursive encapsulation for services constructors 206 which provides encapsulation for members services such as “Members-Service” 208. Encapsulation is illustrated in the Figures by using a background pattern of radiating lines and/or by using heavy-lined box borders. However, it should be apparent that other types of database designs may be used where the specific types of encapsulation illustrated in this example are not always employed.

For illustrative purposes, the kernel object, Object:Kernel 202, is shown providing encapsulation class membership for owner object, Owner:object 210, with recursive object shell members (e.g., 10:11, 10:12, 10:13, 11:3, 12:6, 13:7). In other embodiments, any number of additional members may be included. For ease of illustration, only one or a few example entries or other items are presented.

Object:Kernel 202 provides encapsulation class membership for database, table, column, column display, rows, record and field objects. Each instance of these types of objects (and objects generally presented herein) are referred to by a naming convention such as the following which correspond to the types listed in the prior sentence: Database:object 212; Table:object 214; Column:object 216; Column-Display:object 218; Rows:object 220; Record:object 222 and Field:object 224.

Each object instance may have having recursive object shell members which are entries in Table I as shown in FIG. 6. For example, Database:object 212 includes member entries 14:11, 14:15, 14:16, 15:3, 16:6 and 17:7.

Encapsulation can include encapsulation hierarchies. For example, Database:object 212 is shown encapsulating Table:object 214. Table:object 214 is shown providing encapsulation for Column:object 216, and so on, as indicated by the heavy-lined bounding boxes.

Table II information entries are shown at 250a and 250b. In entries at 250a several encapsulation service class objects are defined as 0=“KERNEL”, 1=“Object”, 2=“Services”, 3=“Members”, 4=“Constructors”, 5=“Services-Script:, 6=“Members-Service:, 7=“Constructors-Service:, 10=“Owner”, 11=“Owner-Member”. These pairs of “type ID=information” correspond to the fields 30 and 32 of Table II 24 in FIG. 1. and are used to define encapsulations of services 18, constructors 34 and dynamic systems 36 of FIG. 1. The number and type of such services or objects and the manner of encapsulations may vary in different embodiments.

Table II entries at 250b defines typical encapsulation database class objects as 12=“Member-Script,: <select . . . ”, 13=“Constructor-Script: <select . . . ”, 14=“Database”, 15=“Database-Member”, 16=“Member-Script: <select . . . , 17=“Constructor-Script: <select . . . ”. These are used to provide further encapsulation for services 18, which can be used to provide further encapsulation for constructors 34, dynamic systems 36, etc. Note that in a particular embodiment, services are dynamic and can be created, deleted or modified.

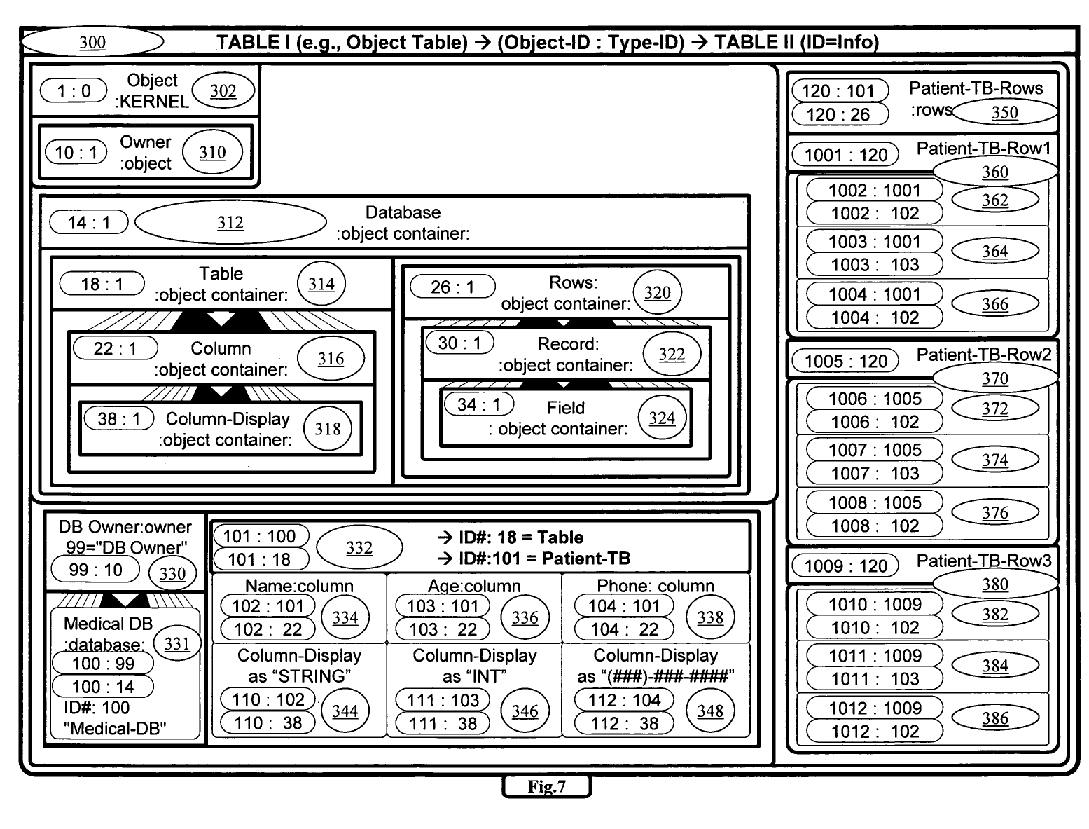

FIG. 7 shows a second part 300 of table entries and information used in conjunction with table entries of first part 200 to illustrate a simplified database service for portion of a medical records database to illustrate embodiments of the invention.

Kernel object 302 is shown providing encapsulation class membership for owner object 310, database object container 312, table object container 314, column object container 316, column display object container 318, rows object 320, record object container 322 and field object container 324.

Owner object, Owner:object 310, provides encapsulation class membership for DB Owner:owner 330 having entry 99:10 and encapsulating Medical DB:database 331 having entries 100:99 and 100:14. DB Owner object DB Owner:object 330 is shown providing encapsulation class membership for Patient-TB:table 332.

Patient-TB:table 332 also encapsulates other objects such as Name column 334, Age column 336, Phone column 338, each of which provides encapsulation for column display 344, 346 and 348, respectively. For illustrative purposes, the Patient TB Rows, (e.g., Patient-TB0-Rows:rows 350) is shown providing encapsulation for rows 360, 370 and 380, which each in turn, provide further encapsulation for members 362, 364, 366, 372, 374, 376, 382, 384, and 386.

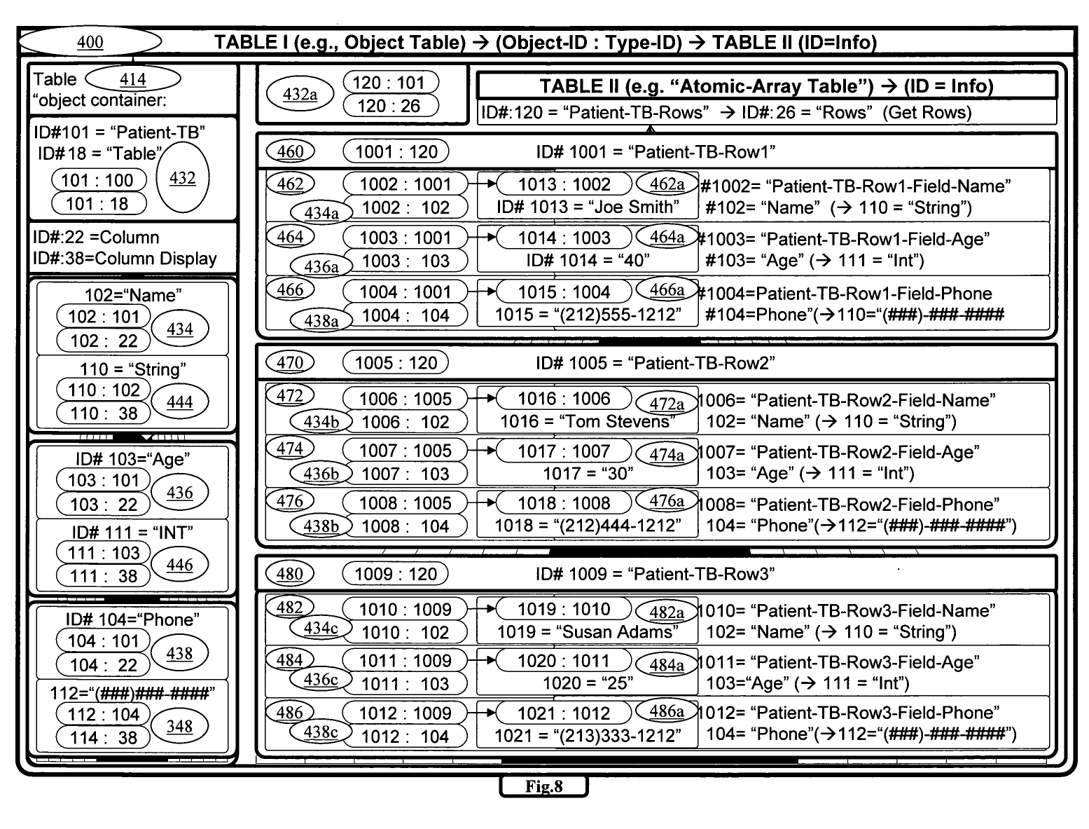

FIG. 8 shows a third part 400 of table entries and information structures relating to table parts 200 and 300 from FIGS. 6 and 7, based on the example 16, 18 of FIG. 1 and illustrates the recursively coupled tables 22, 24 adapted to run a relational object database service for a Medical DB with a Patient Table with rows with Name, Age, and Phone information recursively stored.

For illustrative purposes, table object container 414 is shown providing encapsulation class membership for Patient TB 432 and 432a. Patient-TB members provide encapsulation members (e.g., Name, Age, Phone) in 434, 436, and 438, which in turn, each provide encapsulation members (e.g., String, Age, “( )-” (representing a phone number format)) in 444, 446, and 448.

Patient-TB-Rows members 432a is shown providing encapsulation members (e.g., Patient-TB-Row 1, Patient-TB-Row2, Patient-TB-Row3) in 460, 470, 480, which in turn, each provide encapsulation members 462, 464, 466, 462, 464, 466, 462, 464, and 466.

For illustrative purposes, the Patient-TB-Rows object members 432a (ID=120) are shown to inherit Patient-TB 432 (ID=101) object members, wherein specifically, member 434, 444 are inherited by 434a, 434b, and 434c, and 436, 446 are inherited by 436a, 436b, and 436c, and 438, 448 are inherited by 438a, 438b, and 438c.

Note that the services 400a, 400b, 400c, 400d are meant as an illustrative example of the changing nature of all encapsulated services.

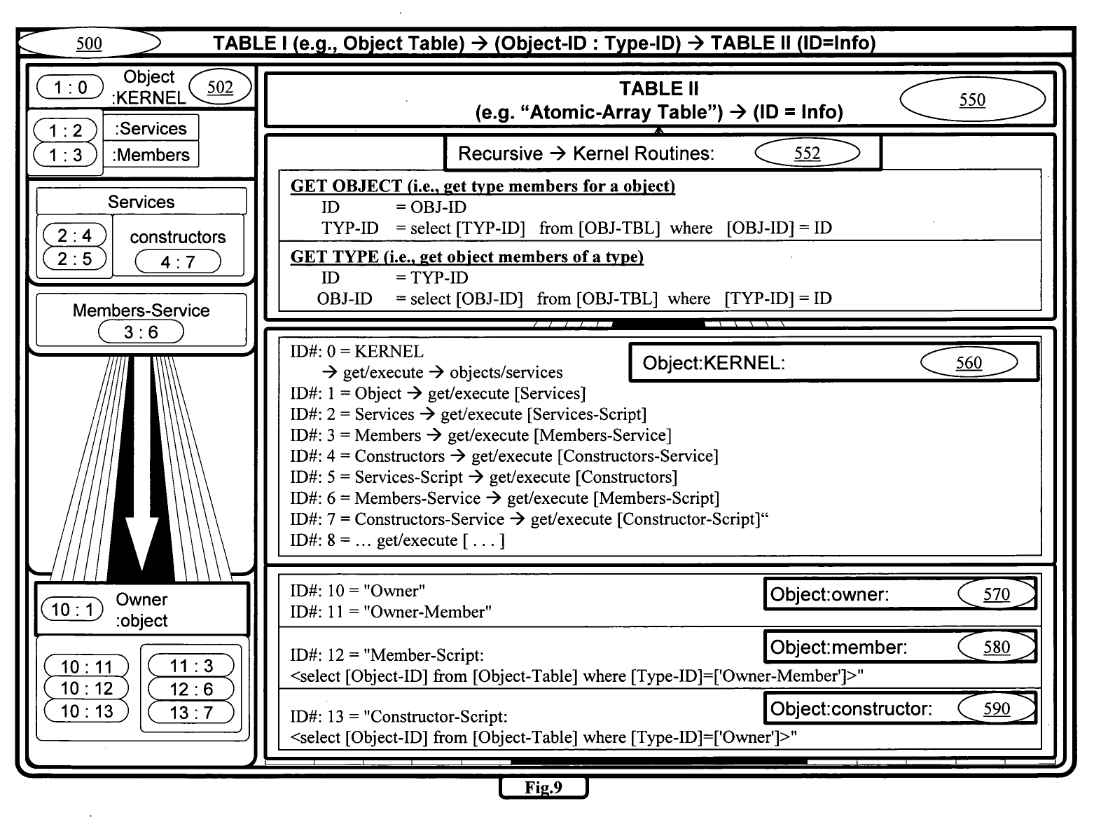

FIG. 9 shows a fourth part 500 of table entries and information adapted with typical service owner, service member and service constructor objects. For illustrative purposes, the table info (e.g., “Table II”) 550 is shown with encapsulation service class objects, (e.g., Object:Kernel 560, Object:owner 570, Object:member 580, Object:constructor 590. In this example, table info 580 contains the following executable script to traverse the recursive objects for this service: ID: 12=“Member-Script: <select [Object-ID] from [Object-Table] where [Type-ID]=[‘Owner-Member’ ]>”. Such script can be written in SQL or any other suitable language. The script provides functionality to perform the three primary relational database functions of insert, update, and deletion. Any other type of functionality may be provided in other embodiments.

Note that object kernel 502 and its recursive members have the same characteristics and properties of object kernels represented in 202, 302 in FIGS. 6,7. Note that the services, object:services, object:owner:services, object:member:services, object:constructor:services, owner:services, member:services, and constructor:services, and other services are merely examples to illustrate a particular application of an embodiment of the invention.

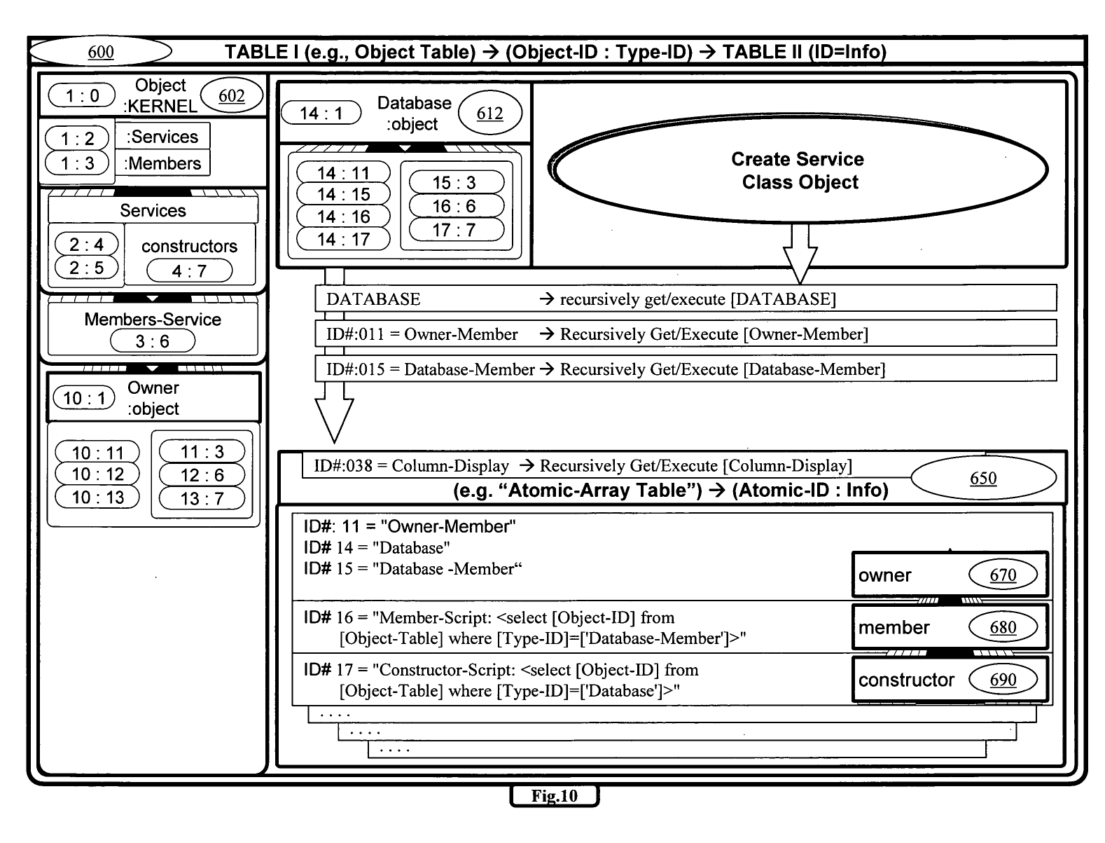

FIG. 10 shows a fifth part of table entries and information adapted with typical database owner, database member and database constructor objects. For illustrative purposes, the table info (e.g., “Table II”) 650 is shown with database owner 670, database member 680 and database constructor objects 690. ID=17, includes the following executable script to traverse the recursive objects for this service: ID: 16=“Member-Script: <select [Object-ID] from [Object-Table] where [Type-ID]=[‘Database-Member’ ]>”. The script provides functionality to perform the three primary relational database functions of insert, update, and deletion. Any other suitable database service class objects may be used in other applications.

Note that in a particular embodiment the object kernel 602, and all of its recursive members, have the same characteristics and properties of object kernels 202, 302 in FIGS. 6 and 7. For example, the database object 602 is identical to the database objects 212 and 312 in FIGS. 6 and 7.

Note that the services, object:services, object:owner:services, object: member: services, object:constructor: services, owner: services, member: services, and constructor:services, represented in 600a, 660a, 670a, 680a, 690a, 670b, 680b, and 690b are meant as an illustrative example of encapsulated services.

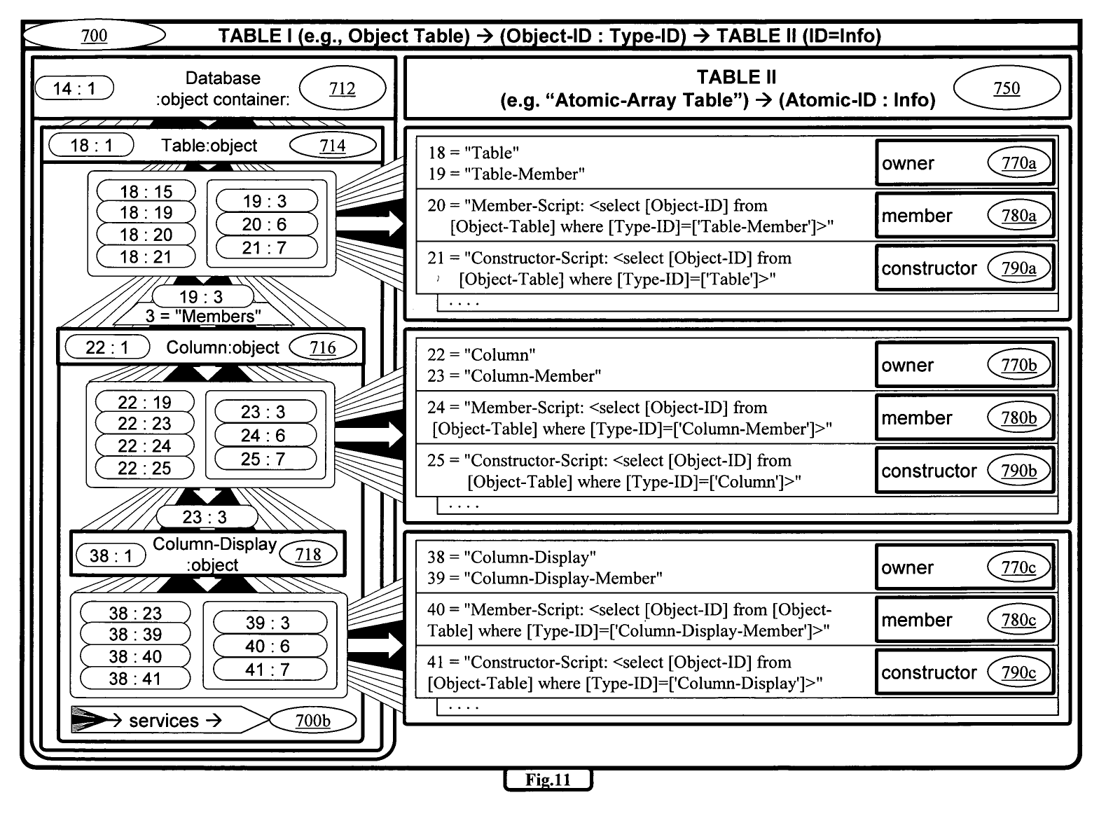

FIG. 11 shows a sixth part 700 of table entries and information adapted with typical table, column, and column-display service class objects. For illustrative purposes, the table info (e.g., “Table II”) 750 is shown with typical table, column, and column-display service class objects, 714, 716, 718 respectively, each of which include, owner, member, and constructor class objects 770a, 780a, 790a, 770b, 780b, 790b, 770c, 780c, and 790c respectively. Database object container 712, and all of its recursive members have the same characteristics and properties of database objects and database object containers 212, 312, 612 in FIGS. 6,7 and 10.

FIG. 12 shows a seventh part 800 of table entries and information adapted with typical rows, record, and field service class objects. For illustrative purposes, the table info (e.g., “Table II”) 850 is shown with rows, record, and field, service class objects, 820, 822, 824 respectively, each of which include, owner, member, and constructor class objects 870a, 880a, 890a, 870b, 880b, 890b, 870c, 880c, and 890c respectively. Table object container 814, and all of its recursive members have the same characteristics and properties of table objects and table object containers 214, 314, 412 in FIGS. 6, 7 and 8.

The kernel object service is used to retrieve relational databases and tables in an exemplary manner as follows:

To display the patient phone number for a particular patient from the patient TB table from the medical DB database, a SQL command is executed that is passed as a parameter to the kernel and the kernel then determines if the current instantiation of the medical database has the current active data and structures, if the current instantiation of medical database has the active records, then the kernel routes the SQL command directly to the RDBMS for execution. If the current instantiation of the medical database does not have the current active data and structures, or if there is no instantiation of the medical database, then the kernel dynamically generates the medical database. The kernel dynamically generates the medical database by recursively retrieving the medical database object records and executing the relevant constructor service scripts which reconstructs the medical database and table structures and provides either a typical relational database view or by dynamically creating an instance of the database on the RDBMS server with typical SQL table create and table insert commands.

If the process is creating a new instance of the database, the kernel process first retrieves object and constructor records for a database object, which it uses to create a virtual instance of the databases, which it uses to map to the database members, which contains the database Medical DB. The kernel then retrieves object and constructor records for table object, which it uses to create a virtual instance of the tables, which it uses to map to the table members, which contains the table patient-TB. The kernel then retrieves object and constructor records for table rows, which it uses to create a virtual instance of the patient TB table rows, which it uses to create an instance on the RDBMS platform, to construct a typical SQL view. The kernel also executes the relevant object constructor services, which in the case of the patient table, includes a table column display object, which will provide the service of converting the phone string of 2125551212, into the display format of “(###)-###-####” as specified by the object service method, resulting in the output of the phone number as “(212)-555-1212”.

The object-ID, type-id, in tables I, II (22, 24 embodiments in FIG. 1) are used to retrieve objects in an exemplary manner as follows:

Object-ID is first used to retrieve database object components, which exists as Type-ID child records (28 embodiment in FIG. 7) in table I (22 embodiment in FIG. 1), and are mapped to Info fields (32 embodiment) in Table II (24 embodiments in FIG. 1). The process then executes the constructor scripts, which exist in the info fields that are indicated by the Type-ID records. This process involves getting all of the member records, and all records for which the object is a member. This involves traversing the object table (Table I) in both directions. For example, the Medical DB object (#ID=100) (331 embodiment in FIG. 7) is used to determine which objects are members of it by searching for all objects with a Type-ID (#ID=100), which returns the Patient-TB (332 embodiment in FIG. 7) object (e.g., #ID=101, (101:100)). The process then determines that Patient-TB object (#ID=101) is a table object by retrieving from object table (Table I) all Type-ID that have object-ID of Patient-TB object (#ID=101), which retrieves table object container 314 embodiment in FIG. 7 (e.g., #ID=18, (101:18) a (18:1))). The process then retrieves all members of Patient-TB object (#ID=101), by retrieving all objects with a Patient-TB object (#ID=101) as the Type-ID, which retrieves column object (334,336,338 embodiments in FIG. 7) (e.g., #ID=102, 103, 104 à (102:101), (103:101) (104:101)), and Patient-TB-Rows object (350 embodiment in FIG. 7) (#ID=120). The column objects (#ID=102, 103, 104) contain the column headings (e.g., Name, Age, Phone). The process then retrieves all members of column objects (#ID=102, 103, 104), by retrieving all objects with a column object (#ID=102, 103, 104) (#ID=101) as the Type-ID, which retrieves column display objects (344, 346, 348 embodiments in FIG. 7) (e.g., #ID=110, 111, 112 à (110:102), (111:103) (112:101)), which contain the column display methods, (e.g., string, int, “(###)###-####”).

The process then retrieves all objects that are members of Patient-TB-Rows object (#ID=120) (350 embodiments in FIG. 7), by retrieving all objects with a Patient-TB-Rows object (#ID=120) as the Type-ID, which retrieves Patient-TB-Row1, Patient-TB-Row2, Patient-TB-Row3, (360, 370, 380 embodiments in FIG. 7) (e.g., #ID=1001, 1005, 1009 a (1001:120), (1005:120) (1001:120)). The process then retrieves all objects that are members of Patient-TB-Row1, Patient-TB-Row2, Patient-TB-Row3, (e.g., #ID=1001, 1005, 1009), by retrieving all objects with a Patient-TB-Row1, Patient-TB-Row2, or Patient-TB-Row3 as Type-ID, which retrieves Patient-TB-Row1,2,3 Field objects, (362, 364, 366, 372, 374, 376, 382, 384, 386 embodiments in FIG. 7), (e.g., #ID=1002, 1003, 1004, 1006, 1007, 1008, 1010, 1011, 1012 à (1002:1001), (1003:1001), (1004:1001), (1006:1005), (1007:1005), (1008:1005), (1010:1009), (1011:1009), (1012:1009). The process then retrieves all objects that are members of Patient-TB-Row1,2,3 Field objects, by retrieving all objects with a Patient-TB-Row1,2,3 Field objects as Type-ID, which retrieves, the so called, Patient-TB-Row1,2,3 Field content objects, (362a, 364a, 366a, 372a, 374a, 376a, 382a, 384a, 386a embodiments in FIG. 8), (e.g., # 1013, 1014, 1015, 1016, 1017, 1018, 1019, 1020, 1021 à (1013:1002), (1014:1003), (1015:1004), (1016:1006), (1017:1007), (1018:1008), (1019:1010), (1020:1011), (1021:1012), which contain the field contents, which it displays using the respective column display methods, (e.g., Joe Smith, 40, (212)555-1212, Tom Stevens, 30, (212)444-1212, Susan Adams, 20, (213)333-1212.).

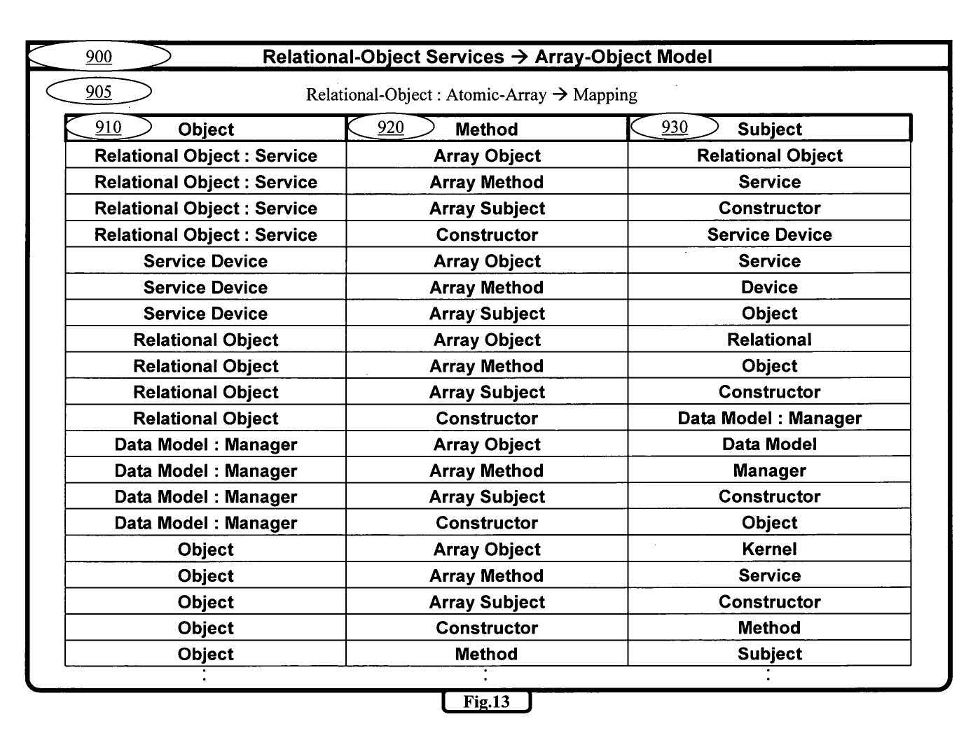

For illustrative purposes, the table 905 of FIG. 13 includes relational object services 64 recursively mapped within the array object model 54, 56 utilizing the three ID fields, Object 910, Method 920 and Subject 930, corresponding to Obj.ID, Meth.ID, Sub.ID of relational object 58 in FIG. 2. The Object, Method and Subject (e.g., Obj.ID, Meth.ID, Sub.ID) are used to retrieve objects in an exemplary manner as follows:

The Object for database is used to retrieve database methods and subjects, wherein a database method will indicate that the object is a database, and that it has database methods, some of which are table and column structures and names, as well as the methods for retrieving the table row data. The methods provide the member scripts to access the tables and retrieve data from them. The method subjects provide method identifiers, like table name and column names. The process then recursively applies the subject table name and subject column name (e.g., Sub.ID) as Objects (e.g, Obj.ID) joined back to the to the Relational Object Table (relational object 58 of FIG. 2.), which retrieves all methods and subjects associated with each table and column object. The methods provide table and column structure, as well as access and display formats and procedures, and method subjects will provide the row field contents, like Name=“Joe Smith”, Age=40, and Phone Number=(212) 555-1212. Those skilled in the art with access to the present teachings may readily design and implement other suitable relational object services.

FIG. 13 shows relational object services 900 based on architecture 50 of FIG. 2 and illustrates the recursively coupled tables adapted to provide relational object services (e.g., relational object: service, or relational object service,) 64 utilizing three pointer ID fields (e.g., Obj.ID, Meth.ID, Sub.ID) within the table relational object

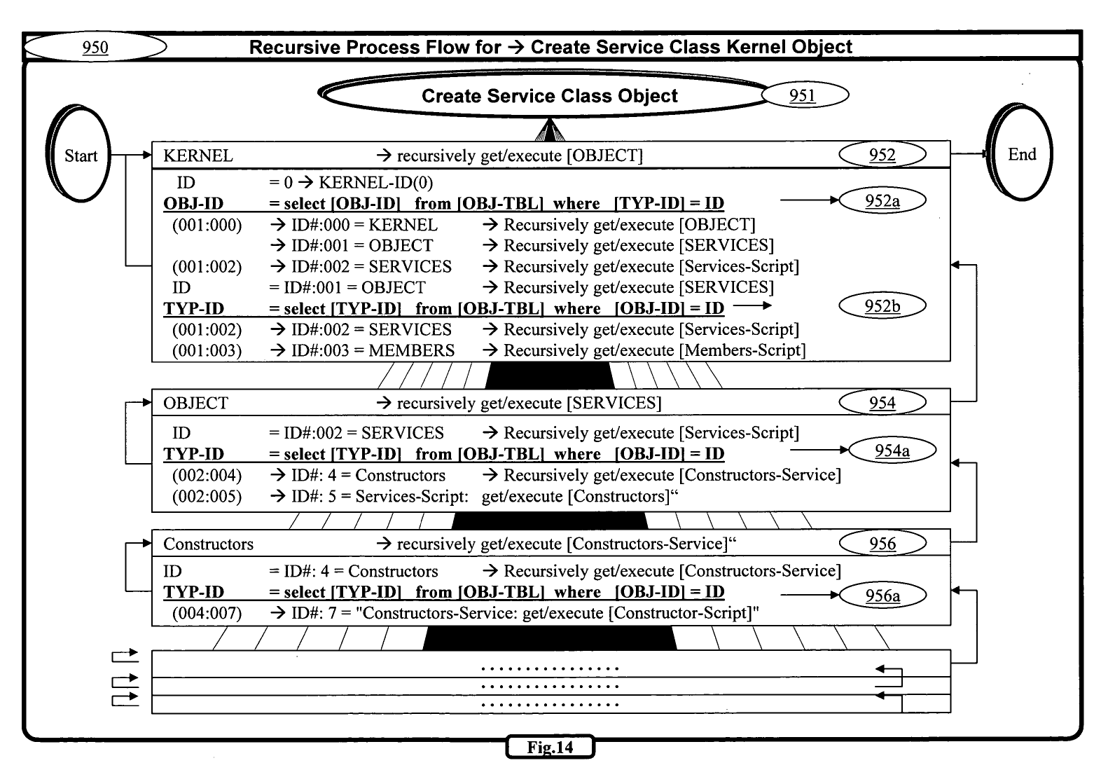

FIG. 14 illustrates a flow diagram for creation of a service class object and illustrates the recursive process flow for creating a service class kernel object with the recursively coupled tables 22, 24 of FIG. 1.

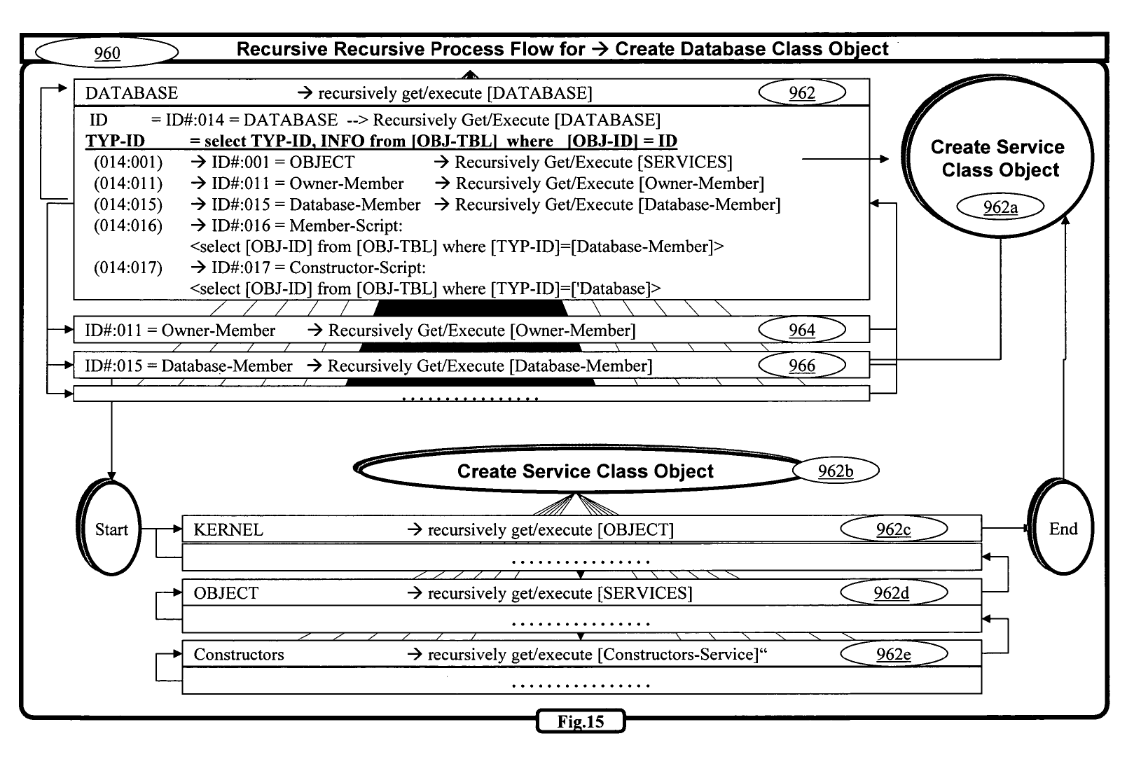

FIG. 15 illustrates a flow diagram 960 for creating a database class object with the recursively coupled tables.

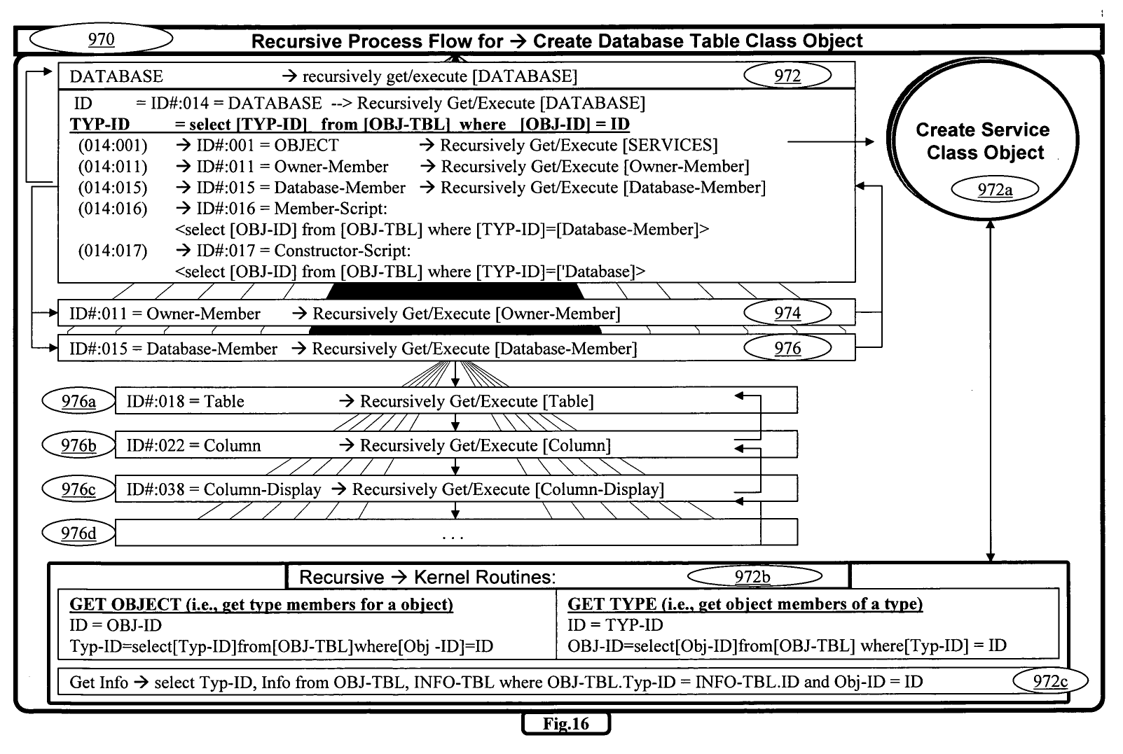

FIG. 16 illustrates is a flow diagram 970 for a recursive process flow for creating a database table class object with the recursively coupled tables.

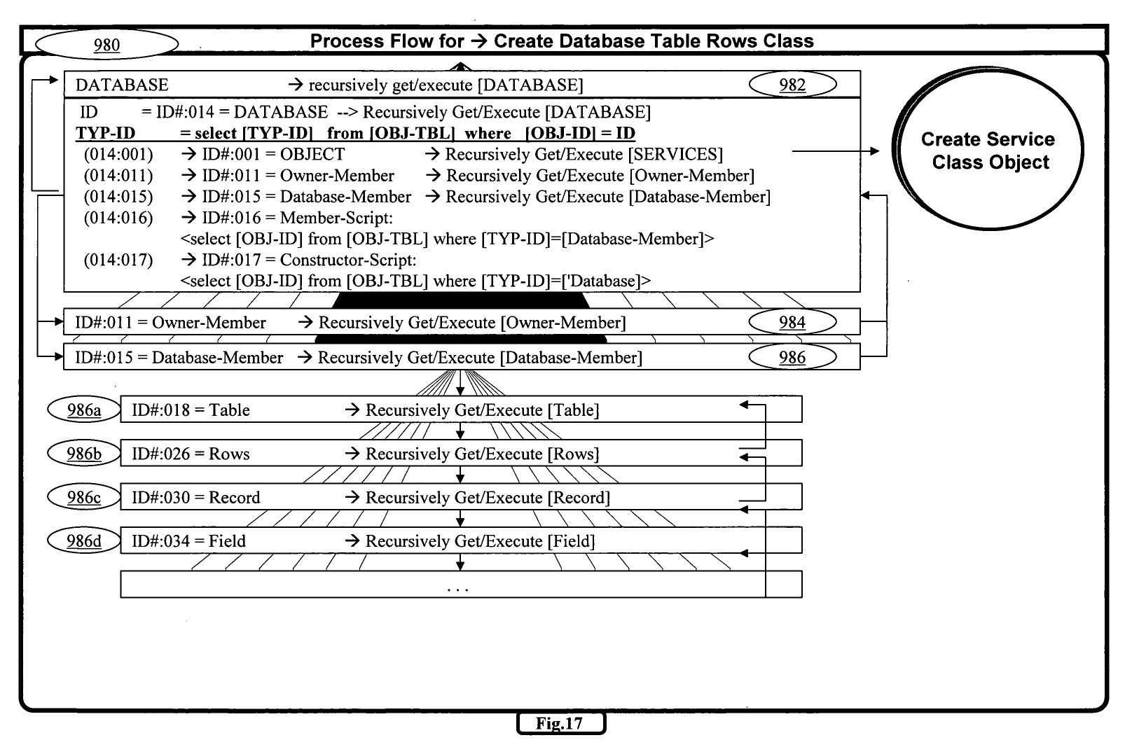

FIG. 17 illustrates a flow diagram is a further illustrative embodiment 980 for creating a database table rows class object with the recursively coupled tables.

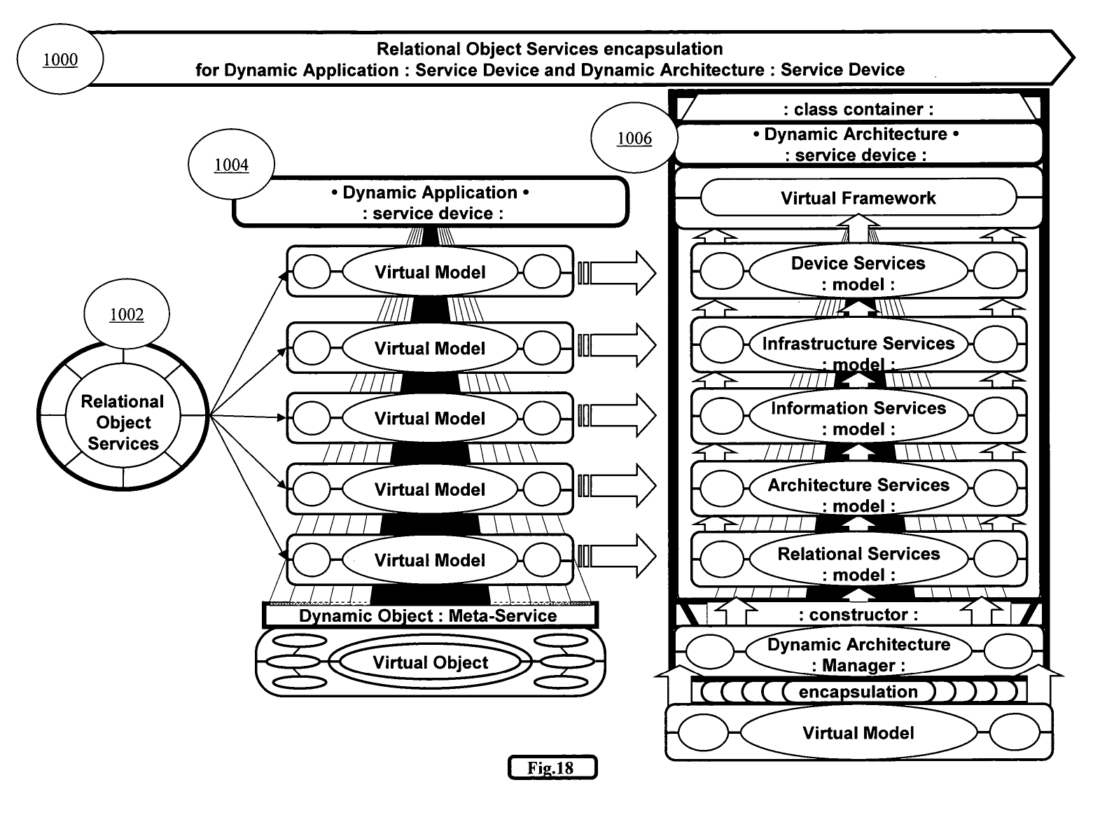

FIG. 18 shows diagram 1000 based on the architecture of FIGS. 1 and 2 and illustrates the recursively coupled tables adapted to provide relational object services (e.g., relational object: service, or relational object service) encapsulation for a dynamic application service device and a dynamic architecture service device (e.g., Dynamic Application: Service Device:, and Dynamic Architecture: Service Device:).

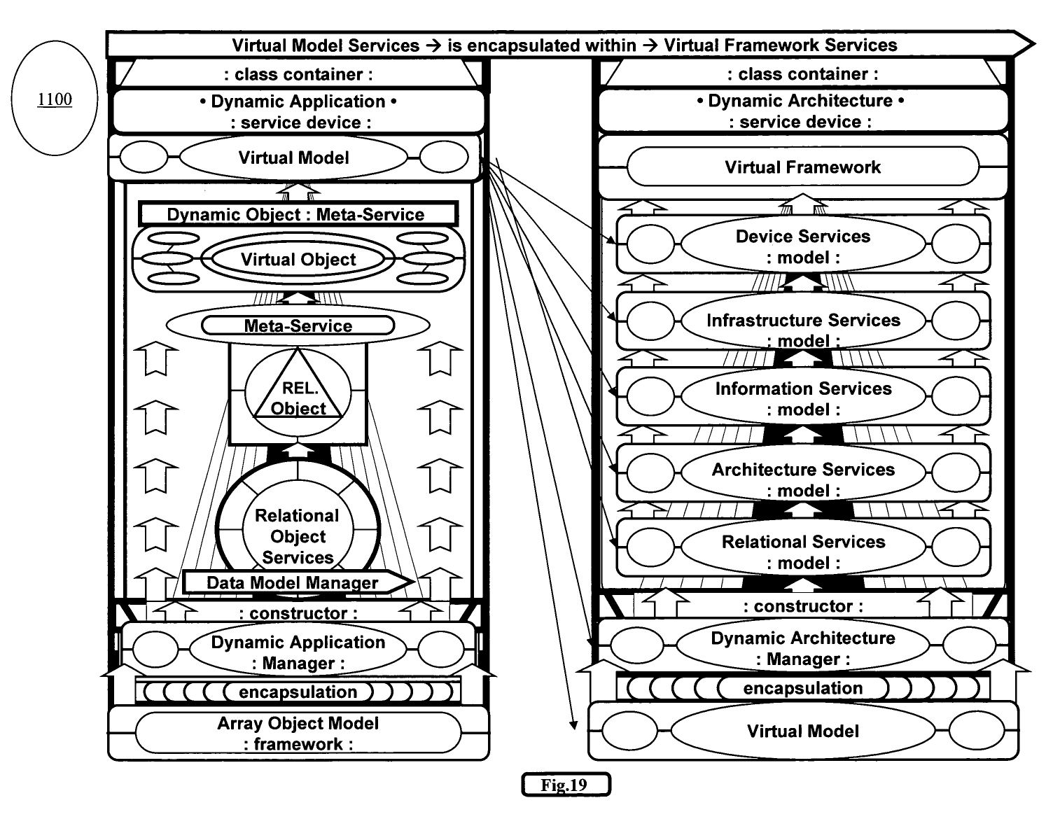

FIG. 19 shows diagram 1100 based on the architecture of FIGS. 1 and 2 and illustrates the recursively coupled tables adapted to provide virtual model relational object services (e.g., relational object: service, or relational object service) encapsulation for a dynamic application service device and a dynamic architecture service device (e.g., Dynamic Application Service Device:, and Dynamic Architecture: Service Device:).

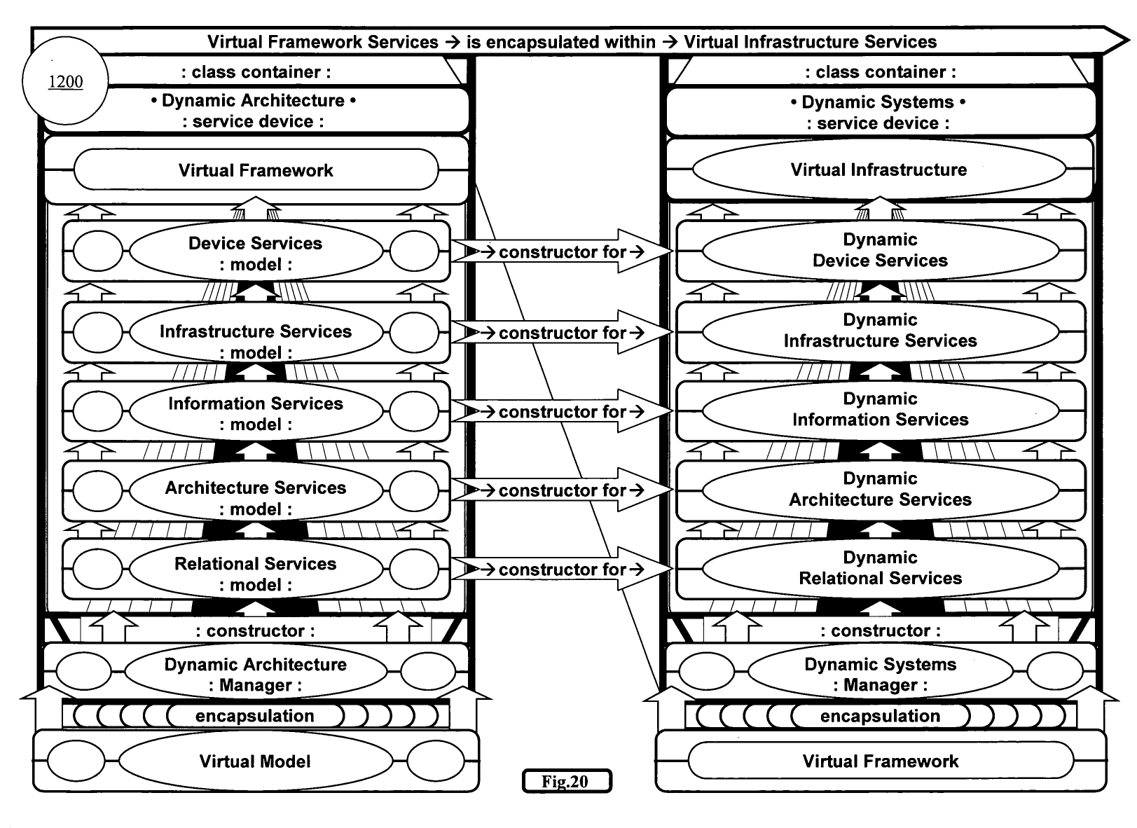

FIG. 20 shows diagram 1200 based on the architecture of FIGS. 1 and 2 and the diagrams of FIGS. 18 and 19 and illustrates the recursively coupled tables adapted to provide virtual framework services encapsulation services (e.g., virtual framework: dynamic architecture: service device) encapsulation for virtual infrastructure services (e.g., virtual infrastructure: dynamic systems: service device, or virtual infrastructure dynamic services: service device).

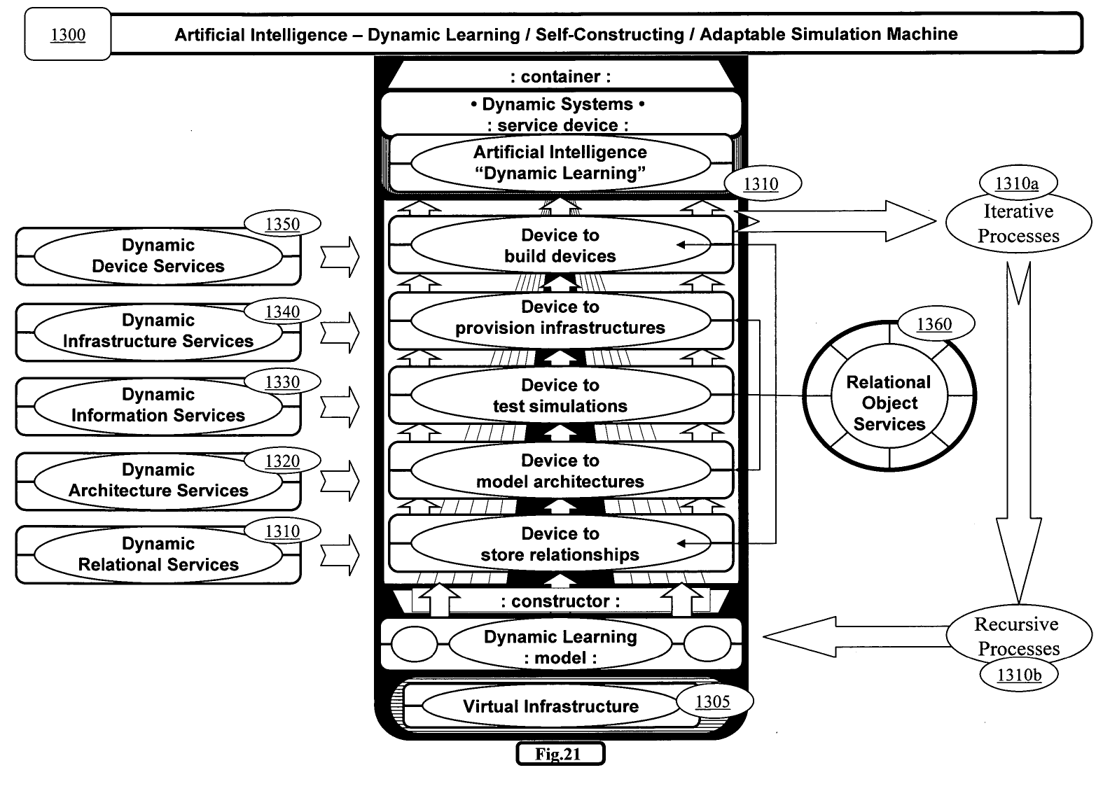

FIG. 21 shows diagram 1300 to describe a general architecture for an artificial intelligence machine that incorporates aspects of the invention described herein. In FIG. 21, five basic services are used to create an object hierarchy to achieve a dynamic learning, self-constructing, adaptable simulation machine. These services include relational 1310, architecture 1320, information 1330, infrastructure 1340 and device 1350 services. These services are arranged in a hierarchy so that object-oriented principles such as encapsulation, inheritance and polymorphism, etc., may be applied.

The field of Artificial intelligence (or AI), includes “the study and design of intelligent agents” where an intelligent agent is a system that perceives its environment and takes actions which maximizes its chances of success. Other names for the field have been proposed, such as computational intelligence, synthetic intelligence or computational rationality. It involves an iterative development or learning process for pattern recognition for condition matching, built around automated inference engines including forward reasoning and backwards reasoning. An intelligent, or learning machine, is said to be adaptable, in all ways. This requires complete recursive thought and processing of information. It must be able to allow for the rise and fall of relational information structures, architectural models, and physical devices within a seamless array of interruptible tasks.

One of the early AI inventions of the implementation of a simulation of the “Game of Life”—a cellular automaton discovered by the mathematician John Conway. The Life field is a grid of square cells, each of which can be either “on” (colored in) or “off” (background color) at any given time. You can think of this as meaning that the colored cells are “alive”, while the grey ones are “dead”. The fate of each cell in the next instant depends on how many of its eight immediate neighbors (including those along the diagonals) are alive in the preceding instant. The rules of Life can be very simply summed up in three simple rules: (1.) cells that have exactly 3 living neighbors at one instant will be “on” in the next instant; (2.) cells that have exactly 2 living neighbors at one instant will stay as they are in the next instant; (3.) cells with any other number of living neighbours at one instant will turn “off” the next instant.

The life game is defined by the rules associated with the relationship between neighboring cells. With this in mind, the study of AI systems must also follow a pattern inherent to biological systems within animals, humans, and all life in general. In humans, the Cerebral cortex is said to be one the most critical and “intelligent” components of the brain stem, it stores memories. The Cerebral cortex stores all memory of all sensory input at the cellular level in identical ways, whether it is auditory, sensory, visually, etc. Even imagined stimulation as information is received and managed at the cellular level with the identical core building blocks. It is a relational machine. It relates and correlates. Research has shown that the brain demonstrates the best ability to recall information if it is recalled through a linear sequence of events. It can be said that the relationship of a linear sequence of time is the easiest to recall because it is the type of relationship that one is most familiar. This is because the cellular structures within the Cerebral cortex have had ample time learn this type of relationship, the relationship called sequence. The types of Relationships that are known to be valid are the easiest to recall because of the frame of reference, by virtue of the relationship to something know. This is the core of any learning entity. It is the defining and interrogating of relationships.

The challenge of AI is not one of increasingly complexity, but rather, it is one of simplicity. As is evident in Albert Einstein how's unending search for a grand unifying theory, the intellect is ever searching to define relationships that unify objects. A relationship object is the most basic and atomic component that comprises and serves as the building blocks of intelligence.

The analogy of building a house will illustrate the usefulness and applicability of these five components.

The design of an architecture includes recursively identifying all of the component pieces necessary to construct the house, i.e., the relationships between objects. A strut, a nail, a roof, etc, are all defined in how they relate to each other, as well as, how they relate to the physics of what is a soundly engineered house.

An architect must recursively design a visual model of the house.

This owner of the house must recursively consider multiple architecture models and evaluate which is the optimal model and what is the optimal location for the house.

The owner must contract a general contractor, who must recursively secure all of the necessary provisions and personnel in order to build the infrastructure of the house.

The general contractor and the work crew must recursively build all of the component structural devices that comprise the house.

This analogy to building a house can be used to describe the process by which a robotics learning machine must be able to store dynamically changing relationships in order to deal with the physical world. A robotic machine must be able to correctly relate a visual depiction of a object, like a piece of wood, with its internal memory database of what wood is. A robotics machine must also be able to create dynamic architectural models of the world in order to navigate through rough terrain, or cross a river. A robotics machine must be able to analyze previous and forward thinking architectures, relationship, infrastructures, and building arrangements in order to make critical decisions about an action or activity. A robotics machine must also be able to provide provisioning infrastructure mechanisms to fix a problem within its own hardware or software, or to build a new piece of hardware or software. And lastly, the robotics machine must be able to build new devices. This is most evident in nano technologies and Field-programmable gate array wherein new devices, or new chip sets, must be constructed dynamically.

While certain embodiments disclosed herein are discussed with respect to providing a new adaptable computing architecture for certain applications, embodiments of the present invention are not limited and may be applicable to any computing infrastructure. For the purposes of the present discussion, an infrastructure may be any set of interconnected structural elements that provide the framework supporting an entire structure.

In general, any suitable programming language can be used to implement features of the present invention including, e.g., C, C++, Java, PL/I, assembly language, etc. Different programming techniques can be employed such as procedural or object oriented. The routines can execute on a single processing device or multiple processors. The order of operations described herein can be changed. Multiple steps can be performed at the same time. Flowchart sequences can be interrupted. The routines can operate in an operating system environment or as stand-alone routines occupying all, or a substantial part, of the system processing.

Steps can be performed by hardware or software, as desired. Note that steps can be added to, taken from or modified from the steps in the flowcharts presented in this specification without deviating from the scope of the invention. In general, the flowcharts are only used to indicate one possible sequence of basic operations to achieve a function.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein, the various databases, application software or network tools may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. In addition, the term “includes” as used herein is intended to mean “includes, but is not limited to” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for handling a database query, wherein a first database includes first data arranged in an object-oriented format, the method comprising:
receiving a relational database query;
translating at least a portion of the first data from the object-oriented format to second data in a second database, wherein the second data is arranged in a relational database format; and
using the second data to provide a response to the relational database query.

2. The method of claim 1, wherein translating comprises:
translating the at least a portion of the data at a time prior to receiving the relational database query.

3. The method of claim 2, further comprising:
performing scheduled translations of the first data to the second data;
storing the second data in a persistent machine-readable medium for database operations during a predetermined interval of time; and
updating the first data by using the database operations prior to a next translation of the first data to the second data.

4. The method of claim 1, wherein translating comprises:
translating the at least a portion of the data at a time of receiving the relational database query.

5. The method of claim 4, wherein the second data is maintained in transient memory.

6. A computing architecture comprising:
a first object defining a first table that includes one or more pointers; and
a second table in communication with the first table, wherein the one or more pointers reference information in the second table.

7. The computing architecture of claim 6, wherein the information includes:
a method adapted to instantiate one or more additional objects, wherein data components of the one or more additional objects are stored via the first table and the second table or instances thereof.

8. The computing architecture of claim 7, wherein the second table includes one or more atomic fields.

9. A computing architecture comprising:
a first table object including:
a first column for identifying one or more objects;
a second column for accessing or invoking additional information associated with each of the one or more objects.

10. The computing architecture of claim 9, wherein the additional information includes:
a method.

11. The computing architecture of claim 10, wherein the first column includes:
one or more object identification pointers or numbers associated with the one or more objects.

12. The computing architecture of claim 11, wherein the second column includes:
one or more pointers to a second table.

13. The computing architecture of claim 12, wherein the one or more pointers point to an object or field in the second table that points back to one or more fields in the first table.

14. The computing architecture of claim 13, wherein the second table includes:
a type table.

15. The computing architecture of claim 12, wherein the first table and the second table are verticalized and include:
one or more atomic fields.

16. A method for implementing computing architecture comprising:
determining an initial set of resources to be initially employed in the computing architecture;
encapsulating each component of the initial set of resources within one or more objects; and
creating an underlying dynamic data structure wherein data and instructions for implementing or encapsulating the initial set of resources or objects associated therewith are stored.

17. The method of claim 16, further including:
encapsulating the underlying dynamic data structure within a first object.

18. The method of claim 17, wherein the first object includes:
a relational object.

19. The method of claim 18, wherein the relational object includes:
a table that includes atomic fields.

20. The method of claim 18, wherein the relational object further includes:
a second table that is recursively coupled to the first table.

21. A computing architecture comprising:
a set of resources, wherein each resource is encapsulated within one or more objects; and
a data structure including one or more dynamic data structures for storing data and instructions pertaining to the one or more objects or resources.

22. The computing architecture of claim 21, wherein the one or more dynamic data structures include:
one or more verticalized database tables.

23. The computing architecture of claim 21, wherein the one or more dynamic data structures represent a data model upon which the architecture is based, and wherein the one or more dynamic data structures are encapsulated within an object.

24. The computing architecture of claim 23, wherein the object includes:
a relational object.

25. The computing architecture of claim 24, wherein the relational object includes:
a first table and a second table.

26. The computing architecture of claim 25, wherein the first table includes:
one or more atomic fields.

27. The computing architecture of claim 25, wherein the second table includes:
one or more atomic fields.

28. The computing architecture of claim 25, wherein the first table includes:
one or more pointers to one or more fields in the second table.

28-A. The computing architecture of claim 25, wherein the second table includes:
one or more pointers to one or more fields in the first table.

29. The computing architecture of claim 21, wherein every component of the computing architecture is incorporated within an object or otherwise separated from other computing resources via a layer of abstraction.

30. A computing architecture comprising:
a first table including:
a first set of fields each associated with a predetermined object; and
a second set of fields associating each predetermined object with a type; and
a second table recursively coupled to the first table, wherein the second table includes:
a third set of fields, where each field of the third set of fields is associated with one or more fields of the first set of fields; and
a fourth set of fields, where each field of the fourth set of fields includes additional information pertaining to each predetermined object.

31. The computing architecture of claim 30, wherein the first table and the second table are encapsulated within an object.

32. The computing architecture of claim 31, further including:
a manager adapted to manage data and instructions in the first table and the second table, and wherein the manager includes instructions stored in one or more of the first table and the second table.

33. The computing architecture of claim 30, wherein the first set of fields and the second set of fields are atomic fields.

34. The computing architecture of claim 30, wherein the first table includes:
a relational object.

35. The computing architecture of claim 34, wherein the second table includes:
an atomic array.

36. The computing architecture of claim 30, wherein the first table and the second table implement a data definition for defining one or more objects.

37. The computing architecture of claim 36, wherein the one or more objects include an object adapted to manipulate the first table and/or the second table.

38. The computing architecture of claim 30, wherein the predetermined object includes a first method object.

39. The computing architecture of claim 38, wherein the first method object is adapted to instantiate one or more additional objects defined via the first table and the second table.

40. The computing architecture of claim 39, wherein the first method object is adapted to selectively instantiate a relational database from the first table and the second table.

41. The computing architecture of claim 40, wherein the first method object is adapted to save data represented via the relational database via the first table and second table.

42. The computing architecture of claim 30, wherein the predetermined object includes:
a second method, wherein the second method is adapted to encapsulate a static data structure via an object that includes the first table and the second table.

43. The computing architecture of claim 30, wherein the predetermined object includes an object that encapsulates the first table and the second table.

44. The computing architecture of claim 30, wherein the first table and the second table are implemented via a verticalized database that includes one or more objects.

45. The computing architecture of claim 44, wherein a specification for Structured Query Language (SQL) is incorporated as a method within the one or more objects.

46. The computing architecture of claim 45, wherein the one or more objects are incorporated within a Remote DataBase Management System (RDBMS).

47. A method for designing an artificial intelligence system, the method using a digital processor to execute the following actions:
using an object-oriented hierarchy of services as follows:
using a relational service that is encapsulated by an architecture service;
using the architecture service that is encapsulated by an information service;
using the information service that is encapsulated by an infrastructure service;
using the infrastructure service that is encapsulated by a device service; and
using the device service.

48. The method of claim 47, wherein the artificial intelligence system is adapted to the management of multi-core processors to support dynamic coupling and decoupling of services.

49. The method of claim 47, wherein the artificial intelligence system is adapted to design of a field-programmable gate array (FPGA), wherein a new FPGA is constructed dynamically.

50. The method of claim 47, wherein the artificial intelligence system is adapted to a robotics learning machine, the method further comprising:
stores dynamically changing relationships about the physical world; and
processing the relationships in order to determine a robotic behavior.
